(19) United States
(12) Patent Application Publication
(10) Pub. No.: US 2019/0206244 A1
(43) Pub. Date: Jul. 4, 2019

(54) TRAFFIC LIGHT CONTROL DEVICE, TRAFFIC LIGHT CONTROL METHOD, AND RECORDING MEDIUM

(71) Applicant: NEC Corporation, Tokyo (JP)

(72) Inventor: Katsuhiko TAKAHASHI, Tokyo (JP)

(73) Assignee: NEC Corporation, Tokyo (JP)

(21) Appl. No.: 16/307,561

(22) PCT Filed: Jun. 12, 2017
(86) PCT No.: PCT/JP2017/021686

§ 371 Date: Dec. 6, 2018

(30) Foreign Application Priority Data
Jun. 15, 2016 (JP) 2016-118982

(51) Int. Cl. G08G 1/07; G08G 1/087

(52) U.S. Cl. CPC G08G 1/07; G08G 1/005; G08G 1/087

(57) ABSTRACT

The purpose of the present invention is to provide a technology for improving the efficiency of road traffic flow. The traffic light control device includes: a control information generation unit which, on the basis of planned traveling route information which indicates a planned traveling route found on the basis of the current location of a vehicle and the destination of the vehicle, generates control information to be used for performing on/off control of traffic lights disposed on the planned traveling route; and a transmission unit for transmitting the control information to the traffic lights to be controlled.

### CROSS-REFERENCE TO RELATED PATENT APPLICATIONS

This application is a National Stage Entry of International Application No. PCT/JP2017/021686, filed Jun. 12, 2017, which claims priority from Japanese Patent Application No. 2016-118982, filed Jun. 15, 2016. The entire contents of the above-referenced applications are expressly incorporated herein by reference.

### TECHNICAL FIELD

The present disclosure relates to a traffic light control device, a traffic control system, a traffic light control method, and a recording medium.

### BACKGROUND ART

Many traffic light machines which control traffic are uniformly controlled based on the past statistical traffic flow information of a road. A traffic management system is introduced in some intersections. This traffic management system detects a vehicle entering a right-turn-only lane by a vehicle sensor, and extends a lighting time of a right turn signal arrow, thereby efficiently processing a vehicle turning right.

Furthermore, as a publicly known technique of more minutely controlling a traffic light machine, PTL 1 discloses a traffic light control device which recognizes, by a roadside camera, a traffic status and a number of stopping vehicles for each traffic lane of vehicle at an intersection, and controls a traffic light machine depending on a traffic volume. Moreover, PTL 2 discloses a pedestrian crossing aid system which identifies a specific pedestrian by a camera and thus controls switching of a traffic light machine in order that an elderly person, a physically disabled person, or the like can safely cross.

### CITATION LIST

### Patent Literature

[PTL 1] Japanese Unexamined Patent Application Publication No. 2012-221091

[PTL 2] Japanese Unexamined Patent Application Publication No. 2001-101576

### SUMMARY OF INVENTION

### Technical Problem

As described above, a traffic light machine is basically controlled at timing designed based on the past statistical information. Moreover, in the above-described techniques related to PTLs 1 and 2, in order to increase efficiency of a traffic system, a sensor which detects presence of a vehicle or a pedestrian at each individual intersection is disposed, and a traffic light machine is controlled dynamically depending on presence or absence of the vehicle or the pedestrian at a current time.

However, an actual situation is that a number of intersections where the sensor which detects presence of the vehicle or the pedestrian is disposed is extremely limited, and many traffic light machines are controlled at timing planned based on the past statistical information. Therefore, there often occurs such a problem that, even when no vehicle is running on a road orthogonal to a road where a vehicle is running, the vehicle needs to stop at a red light, or time of a green light is short for a traffic flow volume, which causes a vehicle to remain at a stop. Thus, problems such as unnecessary lengthening of a moving time of a vehicle, deterioration of fuel efficiency, and increase of exhaust gas are still on a way of improvement.

Therefore, an object of the present disclosure is to provide a technique which improves moving efficiency in road traffic.

### Solution to Problem

A traffic light control device of an embodiment according to the present invention includes:

a control information generation unit that, based on planned moving route information representing a planned moving route of a vehicle calculated using a current location of the vehicle and a destination of the vehicle, generates control information on controlling turning on and off a traffic light machine on the planned moving route; and

a transmission unit that transmits the control information to the traffic light machine to be controlled.

A traffic control system of an embodiment according to the present invention includes:

an in-vehicle device that calculates a planned moving route of a vehicle using a current location of the vehicle and a destination of the vehicle and transmits planned moving route information on the planned moving route;

a traffic light control device; and

a traffic light machine,

wherein the traffic light machine includes
a lighting unit; and
a lighting control unit that controls the light unit based on the control information.

A traffic light control method of an embodiment according to the present invention includes:

based on planned moving route information representing a planned moving route of a vehicle calculated using a current location of the vehicle and a destination of the vehicle, generating control information on controlling turning on and off a traffic light machine on the planned moving route; and

transmitting the control information to the traffic light machine to be controlled.

Note that a computer program which achieves the above-described device, system, or method by a computer, and a computer-readable non-transitory recording medium storing the computer program also fall within the present invention.

### Advantageous Effects of Invention

According to the present disclosure, it is possible to provide a technique which improves moving efficiency in road traffic.

### BRIEF DESCRIPTION OF DRAWINGS

FIG. 1 is a functional block diagram illustrating one example of a functional configuration of a traffic light control device according to a first example embodiment.

FIG. 2 is a flowchart illustrating one example of an operational flow of the traffic light control device according to the first example embodiment.

FIG. 3 is a drawing illustrating one example of a configuration of a traffic control system according to a second example embodiment.

FIG. 4 is a functional block diagram illustrating one example of a functional configuration of the traffic control system according to the second example embodiment.

FIG. 5 is a drawing illustrating one example of traffic light machine information.

FIG. 6 is a drawing illustrating a road condition.

FIG. 7 is a diagram illustrating one example of a relation between an elapsed time from a current time and a moving distance of a vehicle.

FIG. 8 is a graph illustrating one example of a relation between an elapsed time from a current time and a distance from a current location to a traffic light machine.

FIG. 9 is a diagram illustrating one example of a relation between an elapsed time from a current time and a moving distance of a vehicle when the diagram of FIG. 7 is laid over the graph of FIG. 8.

FIG. 10 is a diagram illustrating one example of a relation between an elapsed time from a current time and a moving distance of a vehicle when a lighting period of a red light of a traffic light machine is shifted in the diagram of FIG. 9.

FIG. 11 is a drawing illustrating one example of a state in a vicinity of a crossroad intersection.

FIG. 12 is a drawing illustrating one example of a diagram concerning each of two vehicles.

FIG. 13 is a drawing illustrating one example of a diagram concerning each of two vehicles when the lighting period of a red light of a traffic light machine is shifted in FIG. 12.

FIG. 14 is a flowchart illustrating one example of an operational flow of the traffic control system according to the second example embodiment.

FIG. 15 is a functional block diagram illustrating one example of a functional configuration of a traffic control system according to a third example embodiment.

FIG. 16 is a flowchart illustrating one example of an operational flow of the traffic control system according to the third example embodiment.

FIG. 17 is a functional block diagram illustrating one example of a functional configuration of a traffic control system according to a fourth example embodiment.

FIG. 18 is a drawing illustrating one example of an overall configuration of a traffic control system according to a fifth example embodiment.

FIG. 19 is a functional block diagram illustrating one example of a functional configuration of the traffic control system according to the fifth example embodiment.

FIG. 20 is a flowchart illustrating one example of an operational flow of the traffic control system according to the fifth example embodiment.

FIG. 21 is a drawing exemplarily describing a hardware configuration of a computer (information processing device) which can achieve each example embodiment.

### EXAMPLE EMBODIMENT

### First Example Embodiment

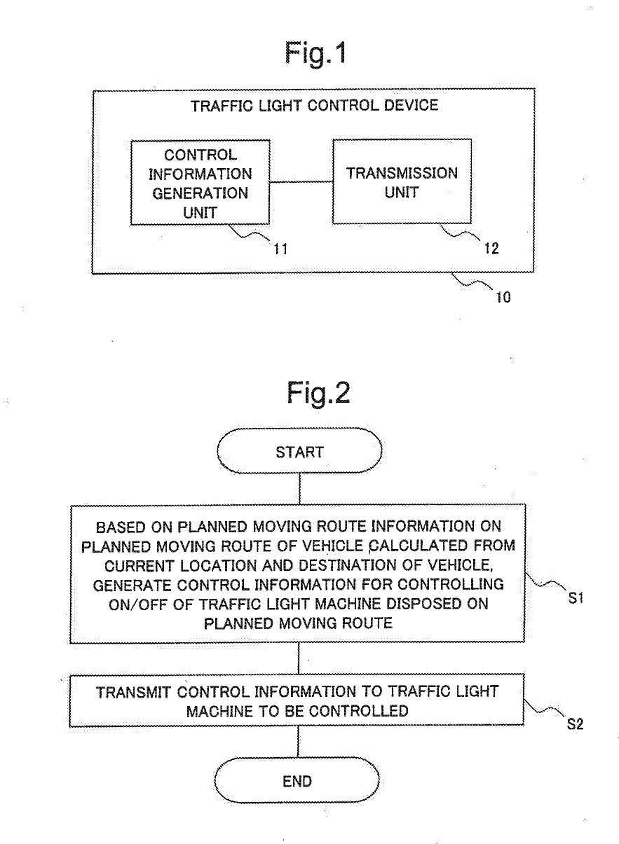

A traffic light control device according to a first example embodiment is described with reference to the drawings. FIG. 1 is a functional block diagram illustrating one example of a functional configuration of a traffic light control device 10 according to the first example embodiment. As illustrated in FIG. 1, the traffic light control device 10 according to the first example embodiment includes a control information generation unit 11 and a transmission unit 12.

Based on planned moving route information representing a planned moving route of a vehicle calculated using a current location and a destination of the vehicle, the control information generation unit 11 generates control information for controlling turning on and off of a traffic light machine on the planned moving route. When a plurality of traffic light machines are disposed on the planned moving route, the control information generation unit 11 generates control information for each of the plurality of traffic light machines.

The planned moving route is calculated by, for example, a general car navigation system. The planned moving route information may be output from an in-vehicle device such as the car navigation system, and input to the traffic light control device 10 via a network, or input to the traffic light control device 10 through another device.

The control information generation unit 11 supplies the generated control information to the transmission unit 12. With the control information, information on the traffic light machine being a transmission destination of the control information is associated.

The transmission unit 12 receives the control information from the control information generation unit 11. The transmission unit 12 transmits the control information corresponding to a traffic light machine to be controlled. In other words, the transmission unit 12 transmits the control information to the traffic light machine represented by information on the traffic light machine associated with the received control information.

FIG. 2 is a flowchart illustrating one example of an operational flow of the traffic light control device 10 according to the first example embodiment. First, based on the planned moving route information calculated using a current location and a destination of each vehicle and representing the planned moving route of the vehicle, the control information generation unit 11 generates the control information for controlling turning on and off of one or a plurality of traffic light machines on the planned moving route for one or each of a plurality of traffic light machines (step S1).

Then, the transmission unit 12 transmits the generated control information to the traffic light machine to be controlled (step S2). Thus, the traffic light machine receiving the control information can control turning on and off of a light instrument included therein based on the control information.

As described above, in the traffic light control device 10 according to the first example embodiment, the control information generation unit 11 generates the control information for controlling turning on and off of the traffic light machine based on the planned moving route information, and the transmission unit 12 transmits the control information to the traffic light machine to be controlled. Thus, the traffic light machine receiving the control information can turn on and off the light instrument thereof based on the control information. The control information is generated based on the planned moving route information calculated using the current location and the destination of the vehicle and representing the planned moving route of the vehicle. For example, the control information generation unit 11 generates such a control signal as to turn each of traffic light machines on the planned moving route to a green light at timing when the vehicle passes, for each of the traffic light machines. Thus, the vehicle related to planned moving route information can shorten a moving time. Moreover, when all of the traffic light machines on the planned moving route are green as described above, the vehicle can proceed to the destination without stopping, and the vehicle can therefore improve fuel efficiency and reduce exhaust gas.

Thus, by the traffic light control device 10 according to the first example embodiment, it is possible to provide a technique which improves moving efficiency in road traffic.

### Second Example Embodiment

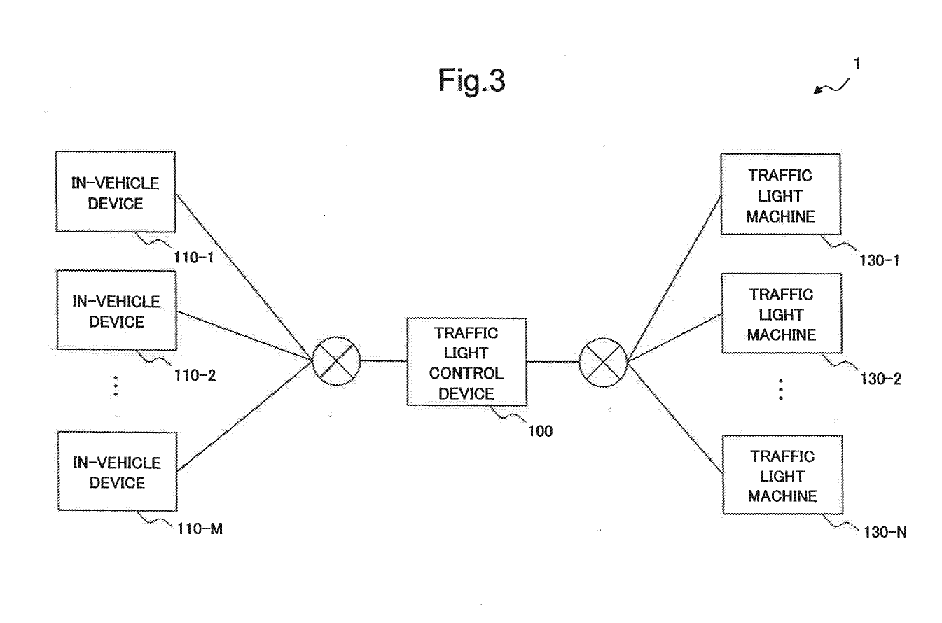

Next, a second example embodiment of the present invention based on the above-described first example embodiment is described with reference to the drawings. First, one example of a configuration of a traffic control system 1 according to the second example embodiment is illustrated in FIG. 3. As illustrated in FIG. 3, the traffic control system 1 according to the second example embodiment includes one or more in-vehicle devices (110-1 to 110-M (M is a natural number)), a traffic light control device 100, and one or more traffic light machines (130-1 to 130-N (N is a natural number)). Note that, in the second example embodiment, the in-vehicle devices (110-1 to 110-M) are referred to as an in-vehicle device 110 when not distinguished from one another or when generically called. Similarly, the traffic light machines (130-1 to 130-N) are referred to as a traffic light machine 130 when not distinguished from one another or when generically called.

The in-vehicle device 110 is a device mounted in a vehicle. The in-vehicle device 110 may be, for example, a car navigation system, a portable terminal such as a smartphone, or any other computer. The in-vehicle device 110 performs, for example, wireless communication with the traffic light control device 100.

The traffic light control device 100 is a device provided in a traffic management center. By performing wireless communication with the in-vehicle device 110, the traffic light control device 100 receives information provided from the in-vehicle device 110. The traffic light control device 100 also performs wired or wireless communication with the traffic light machine 130. The traffic light control device 100 is achieved by a large-scale computer such as a server.

The traffic light machine 130 is achieved by a receiver which receives information from the traffic light control device 100, a light instrument, and a microcomputer or the like which controls lighting of a light instrument.

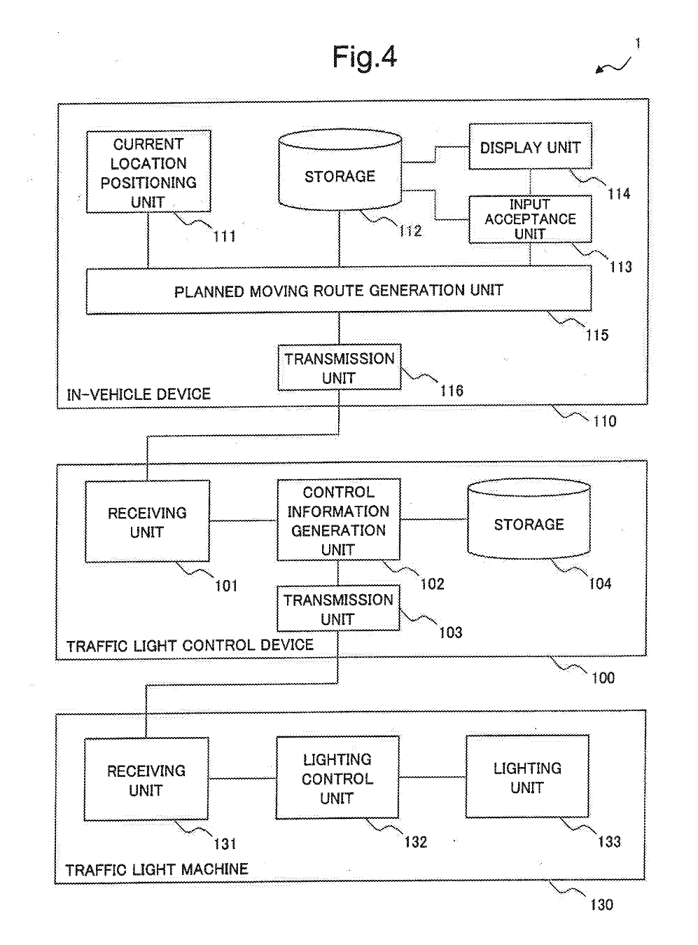

Next, functional configurations of the traffic light control device 100, the in-vehicle device 110, and the traffic light machine 130 of the traffic control system 1 are described. FIG. 4 is a functional block diagram illustrating one example of the functional configurations of the traffic light control device 100, the in-vehicle device 110, and the traffic light machine 130 of the traffic control system 1 according to the second example embodiment. As illustrated in FIG. 4, the in-vehicle device 110 includes a current location positioning unit 111, a storage 112, an input acceptance unit 113, a display unit 114, a planned moving route generation unit 115, and a transmission unit 116. Moreover, the traffic light control device 100 includes a receiving unit 101, a control information generation unit 102, a transmission unit 103, and a storage 104. Further, the traffic light machine 130 includes a receiving unit 131, a lighting control unit 132, and a lighting unit 133.

First, a function of each unit of the in-vehicle device 110 is described.

The current location positioning unit 111 receives location information by utilizing, for example, a global positioning system (GPS), and positions a current location of a vehicle mounted with the in-vehicle device 110 from the received location information. The current location positioning unit 111 is widely used in a general car navigation system or the like. The current location positioning unit 111 supplies information (current location information) on the current location being a positioning result to the planned moving route generation unit 115.

The storage 112 stores road map information being electronic data representing a connection relation of roads, location of a building, and the like. The storage 112 is widely used in a general car navigation system or the like.

The display unit 114 displays, on a screen, information such as the road map information stored in the storage 112. The display unit 114 is achieved by, for example, a liquid crystal display. The input acceptance unit 113 accepts an input operation from a user (e.g., driver). In the second example embodiment, it is assumed that the input acceptance unit 113 and the display unit 114 are integrally formed as a touch panel. The input acceptance unit 113 accepts, for example, an input (also referred to as a destination setting) of a destination to which a vehicle will go. The input of the destination is widely used in a general car navigation system or the like. Note that there is also a driver who does not use a car navigation system to move to a near destination. Thus, the in-vehicle device 110 in the second example embodiment preferably includes a function of displaying, on the display unit 114, a menu or the like enabling the destination to be set with one touch in such a way that destination setting by a driver is encouraged even for moving to a near destination. Accordingly, the later-described traffic light control device 100 can receive destinations input by many drivers and the planned moving route information (described later) generated using current locations and the destinations, and therefore, efficiency of road traffic can be increased. The input acceptance unit 113 may also accept, for example, speech. In this case, the input acceptance unit 113 recognizes the accepted speech, and accepts a result of the speech recognition as an input operation from a user. The input acceptance unit 113 specifies the destination from the accepted input operation by use of, for example, the road map information stored in the storage 112 or the road map information displayed on the display unit 114, and supplies destination information being information on the destination to the planned moving route generation unit 115.

The planned moving route generation unit 115 receives the current location information supplied from the current location positioning unit 111. The planned moving route generation unit 115 also receives the destination information supplied from the input acceptance unit 113. The planned moving route generation unit 115 acquires the road map information from the storage 112, and, using the road map information, the current location information and the destination information, retrieves a route of roads on which the vehicle moves in order to arrive at the destination represented by the destination information from the current location represented by the current location information. Then, based on the retrieved result, the planned moving route generation unit 115 generates the planned moving route information on the planned moving route being a planned route on which a vehicle moves. The planned moving route information on the planned moving route may include a road name, an identification of a traffic light machine to pass, and the like. The planned moving route information may also include current location information and destination information. The planned moving route information itself and a method of generating planned moving route information are widely used in a general car navigation system or the like.

Note that, in the second example embodiment, the planned moving route generation unit 115 preferably generates the planned moving route information that more reflects preference or the like of a driver. Preference of a driver includes, for example, main street priority, by-path priority, or the like. The preference of the driver is preferably reflected by priority particularly in the planned moving route information generated during moving such as commuting or during moving to a destination at a short distance from a garage. This enables the planned moving route generation unit 115 to generate useful planned moving route information. Additionally, when preference of a driver is considered and a plurality of planned moving routes are given as candidates, the planned moving route generation unit 115 may generate the planned moving route information representing each of the plurality of planned moving routes.

The planned moving route generation unit 115 supplies the generated planned moving route information to the transmission unit 116 together with the current location information.

The transmission unit 116 receives the planned moving route information and the current location information from the planned moving route generation unit 115. The transmission unit 116 transmits the received planned moving route information and the current location information to the traffic light control device 100.

Next, a function of each unit of the traffic light control device 100 is described.

The receiving unit 101 receives the planned moving route information and the current location information transmitted from the in-vehicle device 110.

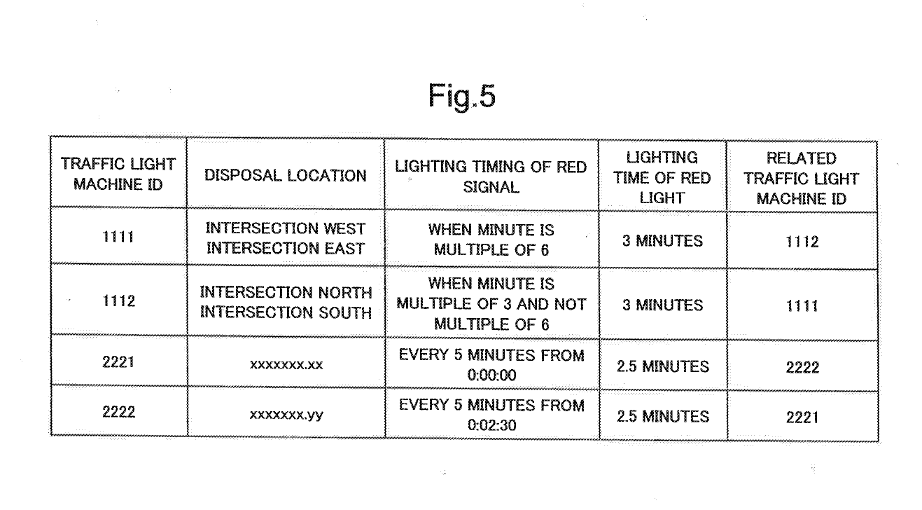

The storage 104 stores, for example, traffic light machine information as illustrated in FIG. 5. The traffic light machine information includes a traffic light machine identifier (ID), a disposal location of the traffic light machine 130, lighting timing of a red light and a lighting time of the red light, and a related traffic light machine ID representing a related traffic light machine 130. Note that the traffic light machine information stored in the storage 104 is one example, and is not limited thereto. For example, the traffic light machine information may include information on lighting timing and a lighting time of another color.

The traffic light machine ID is an identifier for identifying a group combining one or more traffic light machines 130 performing the same lighting operation. When an intersection is relatively large, a plurality of traffic light machines 130 performing the same lighting operation are disposed in some cases. In such a case, the traffic light machine ID is set for a group combining the plurality of traffic light machines 130 performing the same lighting operation. The disposal location is information specified by the traffic light machine ID and representing a location where one or more traffic light machines 130 are disposed. When an intersection is relatively large, the traffic light machines 130 are disposed on a near side and a far side of the intersection in some cases, and the disposal location therefore includes information on the respective locations. Note that the traffic light machine ID may be a name of a traffic light machine.

The related traffic light machine ID represents a traffic light machine ID of a traffic light machine 130 paired with the traffic light machine 130 represented by the traffic light machine ID. Herein, one of the pair of traffic light machines 130 is a traffic light machine which operates in response to an operation of the other traffic light machine 130 and operates differently from the operation of the other traffic light machine 130. For example, in a case of crossed roads, the traffic light machine 130 paired with a traffic light machine 130 disposed on one road is a traffic light machine disposed on another road. Note that, in a case of an intersection where a plurality of roads cross, two or more traffic light machines 130 related to a traffic light machine 130 may be present. Therefore, two or more related traffic light machine IDs may be associated with one traffic light machine ID.

The control information generation unit 102 has a function of the control information generation unit 11 in the first example embodiment. Based on the current location information and the planned moving route information supplied from the receiving unit 101, and traffic light machine information stored in the storage 104, the control information generation unit 102 generates the control information for controlling turning on and off of each of the traffic light machines 130 disposed on the planned moving route represented by the planned moving route information. The control information is also referred to as a control schedule. In the second example embodiment, it is assumed that the control information is information on the lighting timing and the lighting time of the red light of each traffic light machine 130, but may include information on the lighting timing and the lighting time of another color.

An operation of the control information generation unit 102 is described in detail with reference to the drawings.

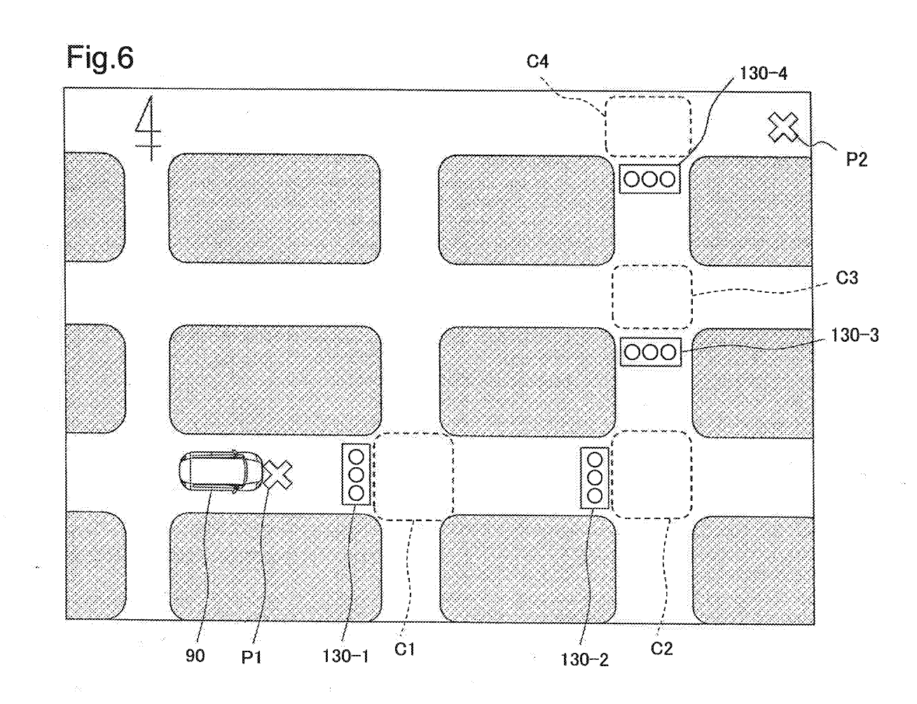

FIG. 6 is a drawing illustrating a road condition. A vehicle 90 illustrated in FIG. 6 is mounted with the in-vehicle device 110. It is assumed that the vehicle 90 moves from a current location P1 to a destination P2. It is assumed that the vehicle 90 moves straight 2 blocks rightward (eastward) in FIG. 6 from the current location P1, then turns left, moves 2 blocks upward (northward), turns right, and moves straight rightward (eastward), thereby moving from the current location P1 to the destination P2. In this case, it is assumed that traffic light machines disposed at an intersection C1, an intersection C2, an intersection C3, and an intersection C4 which the vehicle 90 passes are the traffic light machine 130-1, the traffic light machine 130-2, the traffic light machine 130-3, and the traffic light machine 130-4, respectively. In other words, the planned moving route of the vehicle 90 represented by the planned moving route information transmitted from the in-vehicle device 110 mounted in the vehicle 90 is a route to arrive at the destination P2 from the current location P1 through the traffic light machine 130-1, the traffic light machine 130-2, the traffic light machine 130-3, and the traffic light machine 130-4.

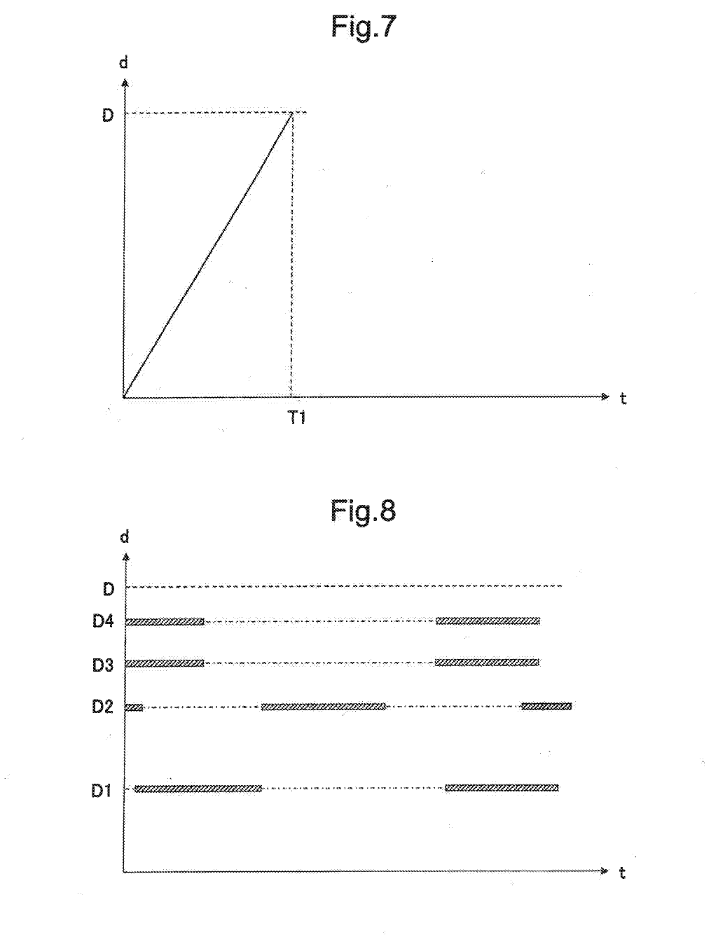

It is assumed that a total distance (distance from the current location P1 to the destination P2) of the route in this instance is D. Herein, a time when the vehicle 90 is located at the current location P1 is referred to as a current time. A diagram in which an elapsed time t from the current time is represented by a horizontal axis and a distance d from the current location P1 is represented by a vertical axis is illustrated in FIG. 7. The distance d is a moving distance of the vehicle 90 from the current location P1, and is therefore also referred to as a moving distance d. In other words, FIG. 7 is a diagram illustrating one example of a relation between the elapsed time t and the moving distance d of the vehicle 90. As illustrated in FIG. 7, the diagram illustrates a case where the vehicle 90 smoothly passes without being caught by a red light at any of the traffic light machines 130-1 to 130-4, and arrives at the destination P2. According to this diagram, it can be understood that the elapsed time t from the current time before the vehicle 90 arrives at the destination P2 from the current location P1 is a time T1. Note that the vehicle speed is constantly fixed even during a right or left turn in a graph in the example of FIG. 7, but an average speed may be altered for each road and for each time by use of a speed limit and width of a partial road, and speed information or the like of another vehicle 90 which has just passed a road section. In this case as well, the traffic light control device 100 can estimate arrival times of each vehicle 90 at the destination P2 and the traffic light machine 130 by merely a part-by-part change of inclination of the diagram.

The control information generation unit 102 calculates the total distance D of a route using the current location information and the planned moving route information supplied from the receiving unit 101. Then, the control information generation unit 102 calculates the time T1 being an elapsed time from the current time before arrival at the destination P2 from the current location P1 by calculating a diagram as illustrated in FIG. 7. Note that information on the total distance D may be included in the planned moving route information.

Next, one example of a period (lighting period) in which red lights of the traffic light machines 130-1 to 130-4 are lighting is illustrated in FIG. 8. In a graph of FIG. 8, the elapsed time t from the current time is represented by a horizontal axis, and the distance d from the current location P1 is represented by a vertical axis, as in FIG. 7. In FIG. 8, a distance D1 represents a distance from the current location P1 to the traffic light machine 130-1. Similarly, a distance D2 represents a distance from the current location P1 to the traffic light machine 130-2, a distance D3 represents a distance from the current location P1 to the traffic light machine 130-3, and a distance D4 represents a distance from the current location P1 to the traffic light machine 130-4. In FIG. 8, the lighting period of the red light of each traffic light machine 130 is represented by a belt-like region. Information on the lighting period of each traffic light machine is information represented by traffic light machine information acquired from the storage 104.

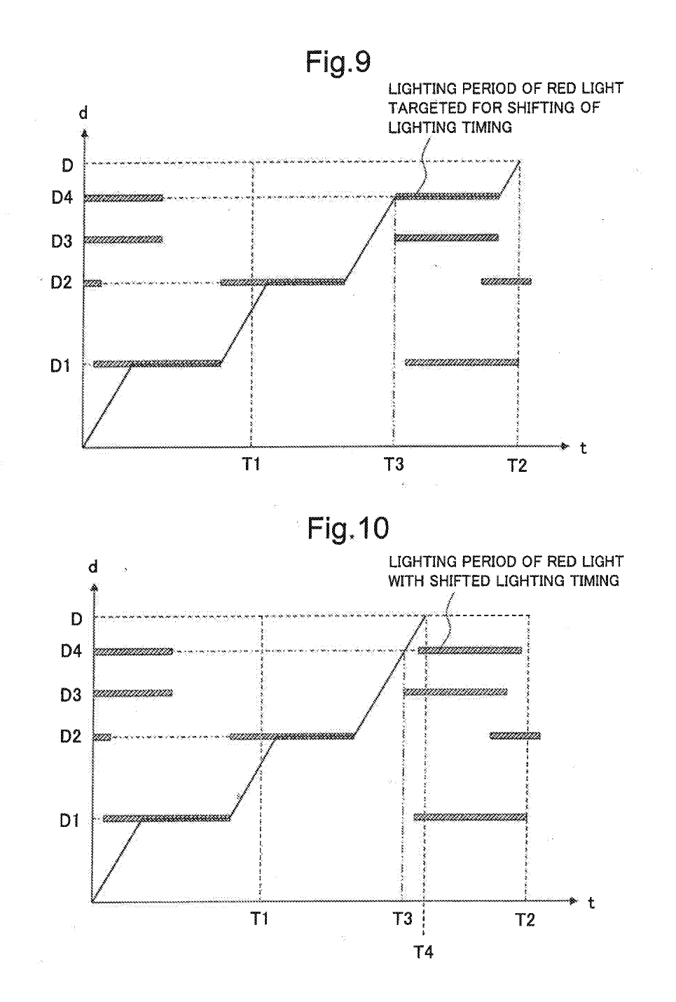

One example of a diagram when the lighting period of the red light of the traffic light machines 130 illustrated in FIG. 8 is laid over the diagram illustrated in FIG. 7 is illustrated in FIG. 9. In FIG. 9, the elapsed time t from the current time is represented by a horizontal axis, and the moving distance d of the vehicle 90 from the current location P1 is represented by a vertical axis, as in FIG. 7. The vehicle 90 stops for a red light, and therefore, when a line of the diagram illustrated in FIG. 7 overlaps a part of the lighting period of the red light, the line of the diagram becomes a horizontal segment. Then, when the light turns green, the line of the diagram again becomes an oblique segment. Thus, FIG. 9 illustrates that the vehicle 90 stops by encountering three traffic light machines (the traffic light machines 130-1, 130-2, and 130-4), and arrives at the destination P2 at a time T2. The example in FIG. 9 illustrates that, when the vehicle 90 arrives at the traffic light machine 130-1, a little time has elapsed since the traffic light machine 130-1 changed to the red light. The example in FIG. 9 also illustrates that the vehicle 90 arrives at the traffic light machine 130-4 immediately after the traffic light machine 130-4 changes to the red light (time T3).

In this instance, for example, by slightly delaying a state change of the traffic light machine 130-4 from the green light to the red light at the time T3 being an elapsed time from the current time as illustrated in FIG. 10, the traffic light machine 130-4 turns to a state of the green light when the vehicle 90 arrives at the traffic light machine 130-4. Therefore, the vehicle 90 can pass the intersection C4 where the traffic light machine 130-4 is disposed, without stopping. Accordingly, the vehicle 90 can arrive at the destination P2 at a time T4 being a time shorter than the time T2. Determination of whether the state change of the traffic light machine 130-4 from the green light to the red light at the time T3 may be delayed may be performed depending on a situation where no other vehicles are present around, or the like. By such a concept, the control information generation unit 102 can create control information (control schedule) of the traffic light machine 130-4.

Thus, the control information generation unit 102 acquires, from the storage 104, the traffic light machine information (specifically, the lighting timing and the lighting time of the red light) of the traffic light machine 130 on the planned moving route (which the vehicle 90 passes). Then, the control information generation unit 102 generates control information for each traffic light machine 130 using the calculated diagram and the acquired traffic light machine information.

Next, one example of a concept of generation of the control information for the traffic light machine 130 is described with reference to the drawings based on the above-described concept of estimating times of arrival at the destination P2 and the traffic light machine 130.

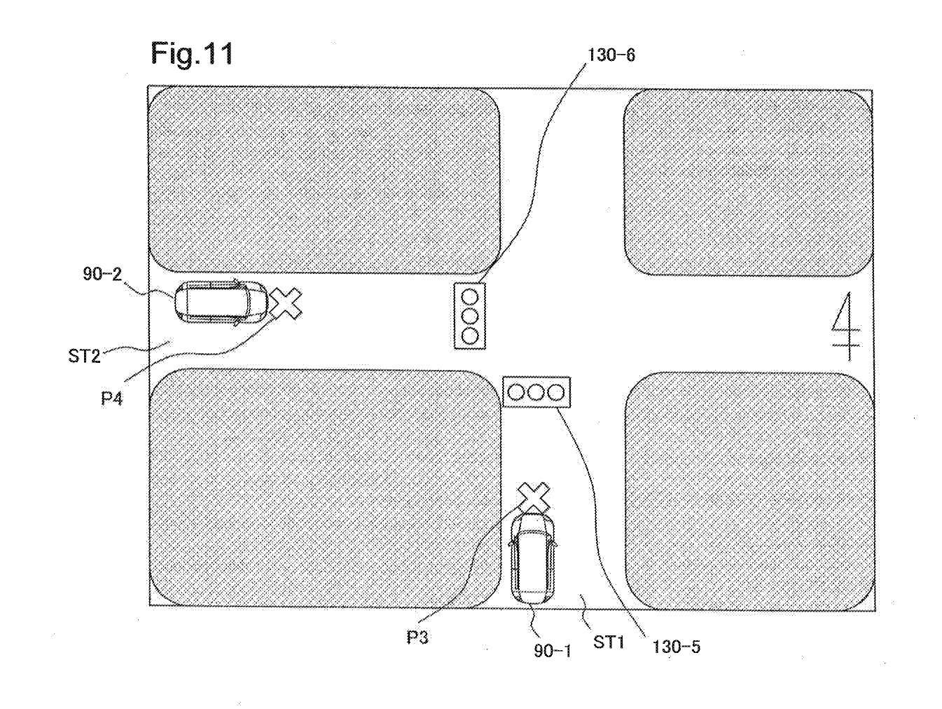

FIG. 11 is a drawing in which a state in the vicinity of an assumed crossroad intersection is illustrated. FIG. 11 schematically illustrates a situation where a vehicle 90-1 is moving northward from a point P3 on a road ST1 extending north and south, and a vehicle 90-2 is moving eastward from a point P4 on a road ST2 extending east and west. Hereinafter, the point P3 is also referred to as a current location P3 of the vehicle 90-1, and the point P4 is also referred to as a current location P4 of the vehicle 90-2. A traffic light machine 130-5 and a traffic light machine 130-6 are disposed on the road ST1 and the road ST2, respectively. The traffic light machine 130-5 and the traffic light machine 130-6 are traffic light machines related to each other, and are traffic light machines having mutually exclusive lighting timing of the green light. Therefore, lighting periods of green lights of the traffic light machine 130-5 and the traffic light machine 130-6 have no overlap in a time direction. It can also be said that lighting periods of red lights of the traffic light machine 130-5 and the traffic light machine 130-6 have no overlap in the time direction for a long time. Note that, in general, when one traffic light machine 130 switches to the red light from the green light, the other traffic light machine 130 switches to the green light from the red light. Thus, there is a period in which two traffic light machines 130 have overlap of lighting of red lights in the time direction, but in the second example embodiment, a description is given on an assumption that two traffic light machines 130 have no overlap of lighting periods of red lights in the time direction, for convenience of description.

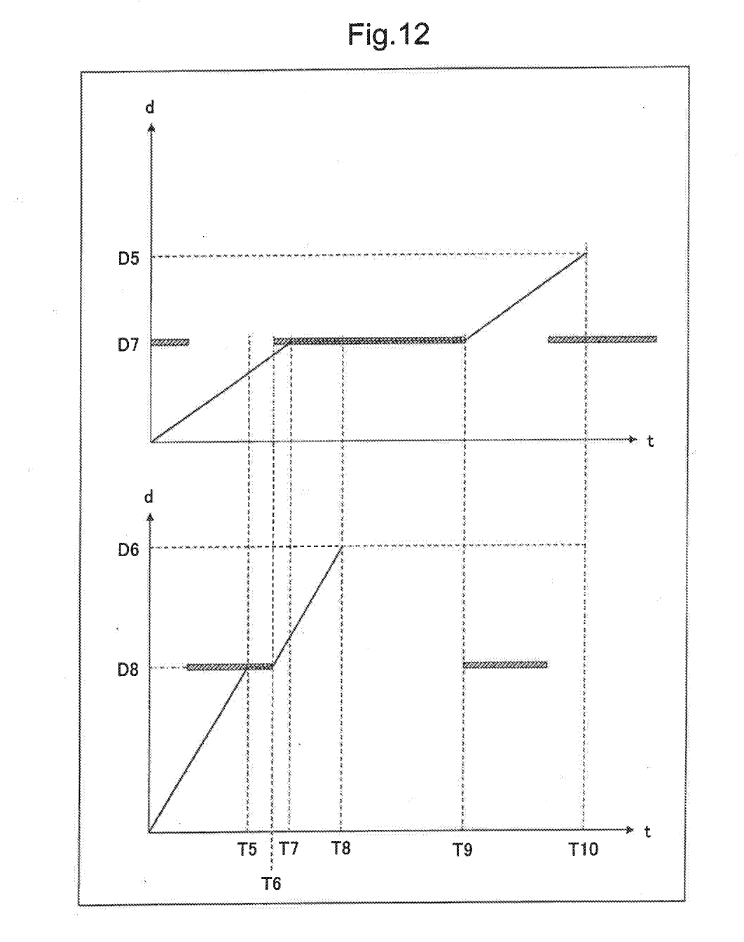

FIG. 12 is a drawing illustrating one example of diagrams concerning the vehicle 90-1 and the vehicle 90-2 illustrated in FIG. 11. In FIG. 12, the diagram illustrated on an upper side is a diagram concerning the vehicle 90-1, and a diagram illustrated on a lower side is a diagram regarding the vehicle 90-2. Specifically, the diagram on the upper side of FIG. 12 is a diagram illustrating one example of a relation between the elapsed time t from a current time and the distance d from the current location P3 which are expected before the vehicle 90-1 moves a distance D5 from the current location P3. Moreover, the diagram on the lower side of FIG. 12 is a diagram illustrating one example of a relation between the elapsed time t from the current time and the distance d from the current location P4 which are expected before the vehicle 90-2 moves a distance D6 from the current location P4.

A distance D7 in the drawing on the upper side of FIG. 12 represents a distance from the current location P3 to the traffic light machine 130-5, and a belt-like region represents the lighting period of the red light of the traffic light machine 130-5. Similarly, a distance D8 in the drawing on the lower side of FIG. 12 represents a distance from the current location P4 to the traffic light machine 130-6, and a belt-like region represents the lighting period of the red light of the traffic light machine 130-6. As understood by comparing the upper and lower drawings of FIG. 12, the lighting period of the red light of the traffic light machine 130-5 and the lighting period of the red light of the traffic light machine 130-6 are mutually exclusive.

In FIG. 12, a time T5 represents a time before the vehicle 90-2 arrives at the traffic light machine 130-6 in which the red light is on from the current time, and a time T6 represents a time when the traffic light machine 130-6 changes to the green light and the vehicle 90-2 again starts moving. As illustrated in FIG. 12, the time T6 can also be said to be timing when the traffic light machine 130-5 changes to the red light.

A time T7 represents a time before the vehicle 90-1 arrives at the traffic light machine 130-5 in which the red light is on from the current time. Moreover, a time T8 represents a time from the current time taken for the vehicle 90-2 to arrive at a point situated at a distance D6 from the current location P4. A time T9 represents a time, from the current time, before the traffic light machine 130-5 changes to the green light and the vehicle 90-1 again starts moving. The time T9 can also be said to be timing when the traffic light machine 130-6 changes to the red light. Moreover, a time T10 represents a time from the current time taken for the vehicle 90-1 to arrive at a point situated at the distance D5 from the current location P3.

The control information generation unit 102 acquires the planned moving route information from the in-vehicle device 110 mounted in the vehicle 90-1, and specifies the traffic light machine 130-5 on the planned moving route represented by the acquired planned moving route information. Then, the control information generation unit 102 acquires the traffic light machine information of the traffic light machine 130-5 from the storage 104, and generates a diagram as illustrated on the upper side of FIG. 12. Similarly, the control information generation unit 102 acquires the planned moving route information from the in-vehicle device 110 mounted in the vehicle 90-2, and generates a diagram as illustrated on the lower side of FIG. 12. Note that a description is given on an assumption that timing when the control information generation unit 102 acquires the planned moving route information from the in-vehicle device 110 of the vehicle 90-1 is substantially the same as timing when the control information generation unit 102 acquires the planned moving route information from the in-vehicle device 110 of the vehicle 90-2. However, the timings may be different. In this case, it is only necessary to apply time adjustment processing to a generated diagram.

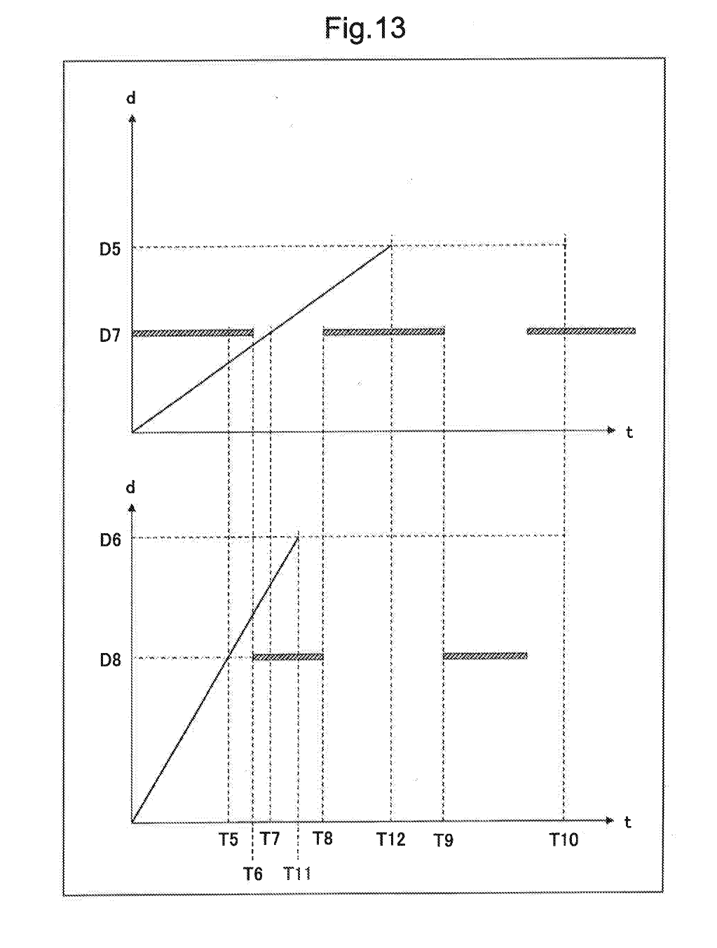

Then, the control information generation unit 102 adjusts, for example, the lighting periods of red lights of the traffic light machine 130-5 and the traffic light machine 130-6 as illustrated in FIG. 13 in order that the vehicle 90-1 and the vehicle 90-2 do not encounter the red light or in order that a time of stopping for the red light becomes shorter. FIG. 13 is a graph representing a relation between elapsed times of the vehicle 90-1 and the vehicle 90-2 from the current time and a moving location from the current location after the lighting period of the red light of the traffic light machine 130-5 and the lighting period of the red light of the traffic light machine 130-6 illustrated in FIG. 12 are controlled. In other words, the diagram on the upper side of FIG. 13 is a diagram after controlling turning on and off of the traffic light machine 130-5 from the diagram concerning the vehicle 90-1 illustrated on the upper side of FIG. 12. Similarly, a diagram on the lower side of FIG. 13 is a diagram after controlling turning on and off of the traffic light machine 130-6 from the diagram concerning the vehicle 90-2 illustrated on the lower side of FIG. 12.

The control information generation unit 102 alters the lighting period of the red light of the traffic light machine 130-6, for example, between the time T6 and the time T8, and alters the lighting period of the red light of the traffic light machine 130-5 before the time T6 and after the time T8. Thus, the control information generation unit 102 can generate a diagram as illustrated in FIG. 13. Accordingly, the control information generation unit 102 can estimate that a time taken when the vehicle 90-1 moves to the location situated the distance D5 from the current location P3 is a time T12. The time T12 is a time shorter than the time T10 as illustrated in FIG. 13. Similarly, the control information generation unit 102 can estimate that a time taken when the vehicle 90-2 moves to the location situated the distance D6 from the current location P4 is a time T11 being a time shorter than the time T8.

In this way, the control information generation unit 102 generates the control information for controlling lighting timings and lighting times of red lights of the traffic light machine 130-5 and the traffic light machine 130-6 in order that stop times of the vehicle 90-1 and the vehicle 90-2 become shorter.

Note that the concept described above is a simple case of two vehicles 90. When a number of vehicles 90 further increases, it is difficult to let all the vehicles 90 pass without waiting at the red light. Thus, when generating the control information for the traffic light machine 130, the control information generation unit 102 may set any evaluation index, and correct the control information (control schedule) in order that a value (evaluation value) calculated by use of the evaluation index is improved. For example, it is considered that the evaluation index more decreases a total of planned moving times of all the vehicles 90, increases an average value of an average speed of each vehicle 90, and weights depending on a kind of a vehicle 90 and decreases a total of all the weighted planned moving times of the vehicles 90.

Furthermore, the control information generation unit 102 may generate the control information by adding a constraint condition such as any vehicle 90 does not stop at the red light for 5 minutes or more, in addition to the evaluation index. The control information generation unit 102 may also generate the control information by combining the evaluation index and the constraint condition. Note that the control information generation unit 102 may hypothetically compute the evaluation index by use of a publicly known traffic simulation system that can simulate behavior of each vehicle.

Weighting performed depending on a kind of the vehicle 90 is, for example, heavily weighting public transport and an emergency vehicle. In this instance, the in-vehicle device 110 may transmit attribute information such as a kind of the vehicle mounted with the device (in-vehicle device 110) in such a way as to associate with the planned moving route information. Then, based on the attribute information associated with the planned moving route information received by the receiving unit 101, the control information generation unit 102 generates the control information in such a way that the above-described evaluation value is improved. This enables the traffic light control device 100 to control the traffic light machine 130 giving more priority to public transport and an emergency vehicle. Moreover, the control information generation unit 102 may generate the control information in order to decrease the above-described evaluation value under such a nonlinear constraint as a time before an emergency vehicle arrives at a destination is less than or equal to a prescribed time.

Furthermore, when hypothetically altering the lighting timing and the period of the red light of the traffic light machine 130 in a case of generating the control information, the control information generation unit 102 may compute the evaluation value, and determine, as the control information, a case where the best evaluation value can be obtained. The control information generation unit 102 may also previously learn a state of the vehicle (number, moving direction, or the like) in association with preferable control information by use of a deep learning technique, acquire the control information according to a state of the vehicle at a current time, and then determine the control information as control information at a current point.

The control information generation unit 102 supplies the generated control information to the transmission unit 103 together with address information on the traffic light machine 130 being a transmission destination of the control information.

The transmission unit 103 has a function of the transmission unit 12 in the first example embodiment described above. The transmission unit 103 transmits the control information received from the control information generation unit 102 to the traffic light machine 130 being an address represented by the address information received together with the control information. Thus, the traffic light machine 130 receiving the control information can turn on the light instrument using the control information.

Next, a functional configuration of the traffic light machine 130 is described.

The receiving unit 131 of the traffic light machine 130 receives the control information transmitted from the traffic light control device 100. The receiving unit 131 supplies the received control information to the lighting control unit 132.

The lighting unit 133 is achieved by the light instrument controlled by the lighting control unit 132.

When receiving the control information from the receiving unit 131, the lighting control unit 132 controls the lighting unit 133 based on the received control information. Specifically, the lighting control unit 132 controls the lighting unit 133 in such a way as to turn on the lighting unit 133 (e.g., red) having a color to be turned on, at the lighting timing based on the control information, and for the lighting time based on the control information. Note that, when the control information includes the lighting timing and the lighting time of another color, the lighting control unit 132 may turn on the lighting unit 133 of another color based on the control information. Moreover, when the control information includes only the lighting timing and the lighting time of the red light, the lighting control unit 132 may control the lighting unit 133 by setting a predetermined time period immediately before the lighting timing of the red signal as the lighting time of a yellow light, and setting a preceding time period in which the red signal is not on as the lighting time of the green light.

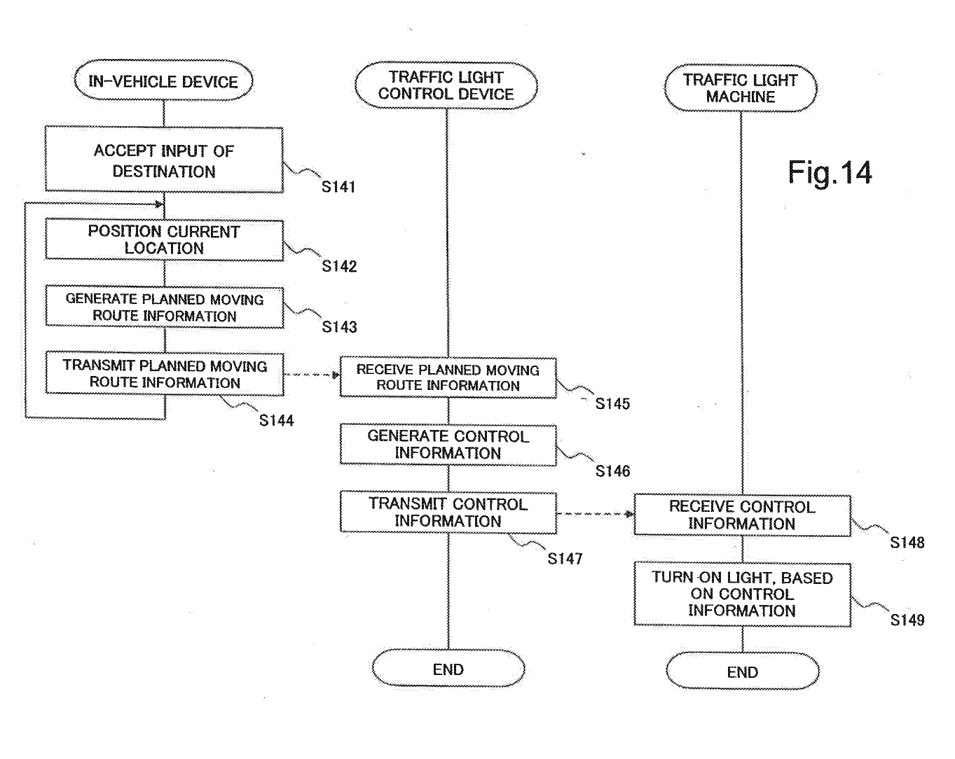

Next, an operation according to the second example embodiment is described with reference to FIG. 14. Note that the in-vehicle device 110, the traffic light control device 100, and the traffic light machine 130 whose operations are illustrated in FIG. 14 cooperate with one another, but operate asynchronously and perform highly independent operations. In FIG. 14, the operation of the in-vehicle device 110 is illustrated on a left side, the operation of the traffic light control device 100 is illustrated in a center, the operation of the traffic light machine 130 is illustrated on a right side, and a broken-line arrow between each operation represents flow of information.

First, the input acceptance unit 113 accepts a destination input by a driver (step S141). Accordingly, the in-vehicle device 110 sets an input place as a destination. When the destination is set, the in-vehicle device 110 repeatedly executes step S142 to step S144 described below until arrival at the destination. Timing of the execution may be each time a predetermined time period is passed, each time a predetermined distance is moved, or any other timing.

After step S141, the current location positioning unit 111 positions a current location (step S142). Then, the planned moving route generation unit 115 generates the planned moving route information on the planned moving route from the current location to the destination, by use of the destination input in S141, the current location positioned in S142, and road map information stored in the storage 112 (step S143). Then, the transmission unit 116 transmits the current location information and the planned moving route information to the traffic light control device 100 (step S144). Then, the in-vehicle device 110 repeats step S142 to step S144.

Note that when the current location positioned in step S142 executed for the second time and after is on the planned moving route represented by the planned moving route information generated in step S143, the planned moving route generation unit 115 may determine that the planned moving route is not altered, and does not need to generate new planned moving route information. In this case, the transmission unit 116 may transmit only the current location information on the current location to the traffic light control device 100. In this instance, when transmitting the planned moving route information for the first time, the transmission unit 116 only needs to transmit information (referred to as vehicle identification information) for identifying the vehicle mounted with the in-vehicle device 110 in association with the planned moving route information, and when transmitting the current location information for the second time and after, the transmission unit 116 only needs to transmit the vehicle identification information in association with the current location information. Thus, an amount of information transmitted to the traffic light control device 100 by the in-vehicle device 110 can be reduced. Moreover, because the vehicle identification information is associated with the current location information, the traffic light control device 100 receiving the current location information can specify the vehicle whose associated route is not changed, and can therefore generate the control information described later.

When the planned moving route information is transmitted from the in-vehicle device 110 together with the current location information, the receiving unit 101 of the traffic light control device 100 receives the planned moving route information together with the current location information (step S145). Based on the planned moving route information received by the receiving unit 101, the control information generation unit 102 generates the control information for each of the traffic light machines 130 disposed on the planned moving route represented by the planned moving route information, and the traffic light machine 130 related to each of the traffic light machines 130 disposed on the planned moving route (step S146). Then, the transmission unit 103 transmits the control information to a corresponding traffic light machine 130 (step S147). Then, the traffic light control device 100 again performs step S145 to step S147 when the planned moving route information is transmitted from the in-vehicle device 110.

Note that, when the receiving unit 101 receives the current location information alone, this represents that there is no change in the planned moving route of the vehicle which has transmitted the current location information, as described above. Therefore, in this case, from the vehicle identification information associated with the current location information, the control information generation unit 102 specifies the planned moving route information associated with the same vehicle identification information as the vehicle identification information. Then, the control information generation unit 102 may generate the control information by use of the specified planned moving route information and the newly received current location information.

When the control information is transmitted from the traffic light control device 100, the receiving unit 131 of the traffic light machine 130 receives the control information (step S148). Then, the lighting control unit 132 controls the lighting unit 133 based on the control information (step S149). Thus, the lighting unit 133 can turn on the color based on the control of the lighting control unit 132 at the timing based on the control information and for the time period based on the control information. Then, when the control information is transmitted from the traffic light control device 100, the traffic light machine 130 again performs step S148 and step S149.

As described above, in the traffic control system 1 according to the second example embodiment, the in-vehicle device 110 calculates, based on the current location of the vehicle and the destination of the vehicle, the planned moving route of the vehicle, and outputs the planned moving route information on the planned moving route. Then, the traffic light control device 100 generates, based on the planned moving route information, the control information for controlling turning on and off of the traffic light machine on the planned moving route, and transmits the control information to the traffic light machine to be controlled. The lighting control unit 132 of the traffic light machine receiving the control information controls turning on and off of the lighting unit 133 based on the control information.

According to the second example embodiment, optimum traffic light machine control is enabled for, for example, both an intersection where a sensor which detects presence of the vehicle is disposed and an intersection where no sensor is disposed, and therefore, moving efficiency in road traffic can be improved. First, regarding the above-described intersection where no sensor is disposed, reasons for this are described. One reason is that, by receiving the current location information and the planned moving route information of the vehicle, the traffic light control device 100 calculates a planned passage time for the traffic light machine which each vehicle plans to pass, and the traffic light control device 100 thereby predicts a traffic volume with a high degree of accuracy, and, based on the prediction, generates the control information for controlling the traffic light machine 130. Another reason is that the traffic light machine 130 turns on and off the light instrument in accordance with the control information. Moreover, also at the intersection where a sensor is disposed, it is possible to perform the current traffic light machine control while taking traffic volume prediction on near future into consideration. For example, when it is estimated that more and more vehicles enter and then congestion aggravates in the future, it is appropriate to eliminate the current congestion as early as possible. On the contrary, when it is likely that vehicles entering the intersection decrease in the future, it can be said that the current congestion does not need to be eliminated quickly. By generating the control information in light of such an estimation result, the control information generation unit 102 can improve moving efficiency of the vehicle in road traffic.

Furthermore, by using the planned moving route information of the vehicle, it is possible to know a direction in which the vehicle entering an intersection moves after passing the intersection. Therefore, for example, at an intersection where many vehicles turn right, when the traffic light machine has a traffic light for a vehicle turning right, the control information generation unit 102 can also generate such the control information as to lengthen the lighting time of the green light in the traffic light machine for a vehicle turning right.

Thus, the traffic control system 1 according to the second example embodiment is based on the planned moving route information of the vehicle, and therefore performs the traffic light machine control using highly reliable near-future information representing when and how many vehicles are likely to pass an intersection or a road in the future. Consequently, it is possible to consider moving efficiency of overall road traffic as compared with the traffic light machine control performed based on the past statistical information or the information about a number of vehicles at an intersection at a current time, and it is therefore possible to improve moving efficiency of the vehicle in road traffic.

### Third Example Embodiment

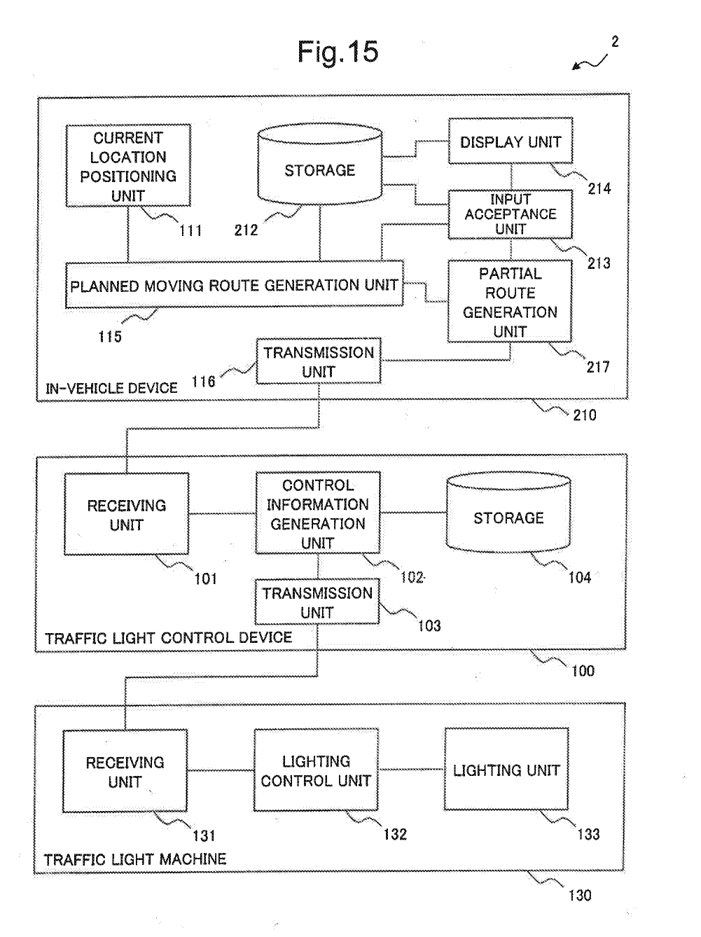

A third example embodiment is described in detail with reference to the drawings. FIG. 15 is a functional block diagram illustrating one example of a functional configuration of a traffic control system 2 according to the third example embodiment. The traffic control system 2 according to the third example embodiment includes an in-vehicle device 210 instead of the in-vehicle device 110 of the traffic control system 1 in the second example embodiment described above. Note that an overall configuration of the traffic control system 2 is similar to the configuration of the traffic control system 1 described with reference to FIG. 3, and a detailed description thereof is therefore omitted. Note that, for convenience of description, the same reference sign is given to a component similar to the component described in the above-described second example embodiment, and a description thereof is omitted.

As illustrated in FIG. 15, the traffic control system 2 according to the third example embodiment includes one or more in-vehicle devices 210, the traffic light control device 100, and one or more traffic light machines 130.

As illustrated in FIG. 15, the in-vehicle device 210 includes the current location positioning unit 111, a storage 212, an input acceptance unit 213, a display unit 214, the planned moving route generation unit 115, the transmission unit 116, and a partial route generation unit 217.

The storage 212 stores road map information in a way similar to the storage 112 described above. The storage 212 also stores contents displayed on the display unit 214. The contents displayed on the display unit 214 are conditions for a user to previously designate a part of the planned moving route from a current location to a destination, and are conditions for generation of a partial route described later. The storage 212 includes, but is not limited to, options as contents displayed on the display unit 214, such as (1) a first half 50% of the planned moving route, (2) a first half 80% of the planned moving route, (3) the whole planned moving route. Other options may be (4) excluding a second half 1 km, (5) excluding a second half 2 km, (6) excluding a second half 5 km, and the like. The storage 212 may also store an option (contents) designated by the user among the options.

In addition to the above-described function of the display unit 114, the display unit 214 selectably displays the options (conditions for partial route generation) stored in the storage 212 on a screen. The input acceptance unit 213 accepts an input operation from the user in a way similar to the input acceptance unit 113 described above. When contents displayed on the display unit 214 are the options stored in the storage 212, the input acceptance unit 213 accepts the input operation from the user, and supplies information representing the selected contents to the partial route generation unit 217. The input acceptance unit 213 may also store the information on the selected contents in the storage 212.

The partial route generation unit 217 receives information supplied from the input acceptance unit 213 and representing the condition for partial route generation being the contents selected by the user. The partial route generation unit 217 also receives the planned moving route information generated by the planned moving route generation unit 115, together with the current location information measured by the current location positioning unit 111. Then, the moving route represented by the planned moving route information generated by the planned moving route generation unit 115 is processed based on the condition for partial route generation selected by the user. For example, when the condition for partial route generation selected by the user is (1) the first half 50% of the planned moving route, the partial route generation unit 217 extracts the first half 50% of the planned moving route. The planned moving route extracted (processed) by the partial route generation unit 217 is also referred to as a partial route. The partial route generation unit 217 may hold, in an unillustrated storage thereof, the information on the contents selected by the user until next reception from the input acceptance unit 213, or may acquire, from the storage 212, the information on the contents selected by the user whenever the partial route generation unit 217 extracts the partial route.

The partial route generation unit 217 supplies partial route information being information on the extracted planned moving route (partial route) as the planned moving route information to the transmission unit 116 together with the current location information. Thus, as in the second example embodiment described above, the transmission unit 116 can transmit the current location information and the planned moving route information to the traffic light control device 100.

Furthermore, whenever the partial route generation unit 217 receives the planned moving route information from the planned moving route generation unit 115, the partial route generation unit 217 extracts the partial route, and supplies the partial route to the transmission unit 116 as the planned moving route information.

Thus, the display unit 214 of the in-vehicle device 210 selectably displays, on the screen, conditions each designating a part to be output out of the planned moving route of the vehicle generated by the planned moving route generation unit 115. When the input acceptance unit 213 accepts the input by the user, the partial route generation unit 217 extracts (generates) the partial route based on the selected condition, out of the planned moving route information. Then, the transmission unit 116 transmits the information on the partial route to the traffic light control device 100 as the planned moving route information.

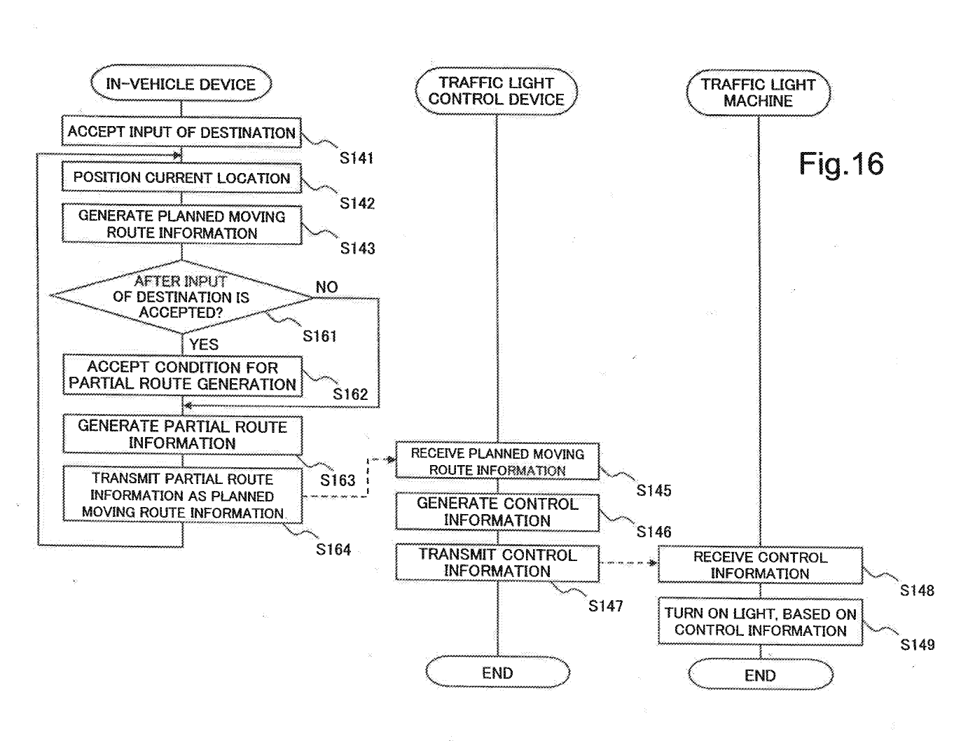

Next, an operation according to the third example embodiment is described with reference to FIG. 16. Note that the in-vehicle device 210, the traffic light control device 100, and the traffic light machine 130 whose operations are illustrated in FIG. 16 cooperate with one another, but operate asynchronously and perform highly independent operations. In FIG. 16, as in FIG. 14, an operation of the in-vehicle device 210 is illustrated on a left side, an operation of the traffic light control device 100 is illustrated in a center, an operation of the traffic light machine 130 is illustrated on a right side, and a broken-line arrow between each operation represents flow of information. Note that the same reference sign is given to an operation similar to the operation of the traffic control system 1 in the second example embodiment illustrated in FIG. 14.

First, the input acceptance unit 213 accepts the destination input by a driver (step S141). The current location positioning unit 111 positions the current location (step S142). Then, the planned moving route generation unit 115 generates the planned moving route information on the planned moving route from the current location to the destination, by use of the destination input in S141, the current location positioned in S142, and the road map information stored in the storage 212 (step S143). Whether it is after the input acceptance unit 213 has accepted the input of the destination is determined (step S161). In other words, it is not until step S141 ends that the input acceptance unit 213 determines whether to perform step S161. When it is after the input acceptance unit 213 has accepted the input of the destination (YES in step S161), the input acceptance unit 213 accepts the condition for partial route generation (step S162).

In a case of No in step S161, i.e., when it is not after the input acceptance unit 213 has accepted the input of the destination, the condition for partial route generation is already accepted, and therefore, the in-vehicle device 210 skips step S162.

Thereafter, the partial route generation unit 217 generates the partial route from the planned moving route based on the condition for partial route generation accepted in step S162 (step S163). Thereafter, the transmission unit 116 transmits the partial route information on the partial route to the traffic light control device 100 as the planned moving route information (step S164). Then, the in-vehicle device 210 repeats step S142 to step S143 and step S161 to step S164.

Thereafter, the traffic light control device 100 receives the planned moving route information together with the current location information (step S145), generates the control information (step S146), and transmits the control information to the corresponding traffic light machine 130 (step S147), as in the second example embodiment described above. Then, the traffic light machine 130 receives the control information (step S148), and controls the lighting unit 133 based on the control information (step S149). Thus, the lighting unit 133 can turn on a color based on the control of the lighting control unit 132 at the timing based on the control information and for the time period based on the control information.

As described above, the planned moving route information received by the traffic light control device 100 in the traffic control system 2 according to the third example embodiment may be at least a part of a planned moving route. This provides advantageous effects of not having to inform the traffic light control device 100 of a destination of a vehicle mounted with the in-vehicle device 210. Thus, the traffic control system 2 can consider privacy for a user who does not want the destination to be known.

### Fourth Example Embodiment

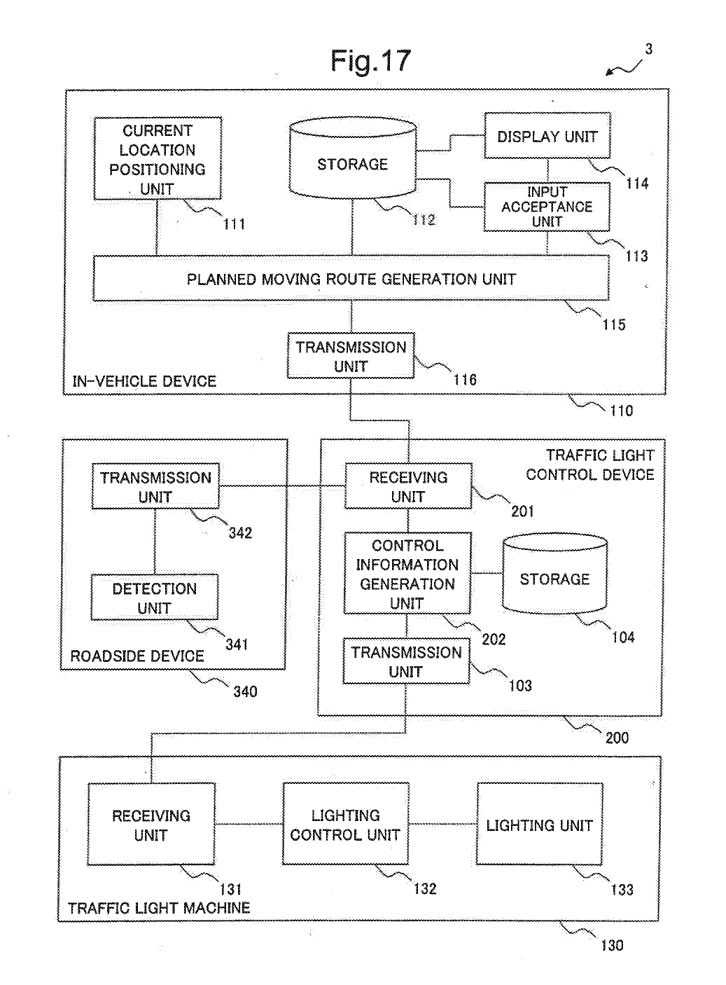

A fourth example embodiment is described in detail with reference to the drawings. FIG. 17 is a functional block diagram illustrating one example of a functional configuration of a traffic control system 3 according to the fourth example embodiment. The traffic control system 3 according to the fourth example embodiment includes a traffic light control device 200 instead of the traffic light control device 100 of the traffic control system 1 in the second example embodiment described above, and further includes a roadside device 340. Note that the traffic control system 3 may be configured in such a way as to include the traffic light control device 200 instead of the traffic light control device 100 of the traffic control system 2 in the third example embodiment described above, and further include the roadside device 340. Moreover, the roadside device 340 may be configured in such a way as to be included in a traffic light machine 130. Note that, for convenience of description, the same reference sign is given to a component similar to the component described in each of the above-described example embodiments, and a description thereof is omitted.

As illustrated in FIG. 17, the traffic control system 3 according to the fourth example embodiment includes one or more in-vehicle devices 110, the traffic light control device 200, one or more traffic light machines 130, and one or more roadside devices 340. The traffic light control device 200 includes a receiving unit 201, a control information generation unit 202, a transmission unit 103, and a storage 104. The roadside device 340 includes a detection unit 341 and a transmission unit 342.

The roadside device 340 is, for example, a device provided near a pedestrian crossing of an intersection. Herein, it is assumed that the traffic light machine 130 is also provided in the pedestrian crossing. The detection unit 341 of the roadside device 340 detects a location and a planned moving direction of a pedestrian. The planned moving direction of the pedestrian is detected from a direction in which a face of the pedestrian is turned, or the like. A method of detecting the pedestrian is not particularly limited, and any method may be adopted. The detection unit 341 supplies a detection result of the pedestrian to the transmission unit 342.

The transmission unit 342 receives the detection result of the pedestrian from the detection unit 341 which has detected the detection result. The transmission unit 342 transmits the received detection result to the traffic light control device 200.

The receiving unit 201 of the traffic light control device 200 receives the detection result of the pedestrian transmitted from the roadside device 340, in addition to the function of the receiving unit 101 described above. The receiving unit 201 supplies the received detection result of the pedestrian to the control information generation unit 202.

The control information generation unit 202 receives the planned moving route information from the receiving unit 201 together with the current location information. Further, the control information generation unit 202 receives the detection result of the pedestrian from the receiving unit 201. Based on the received detection result of the pedestrian, the current location information and the planned moving route information, and the traffic light machine information, the control information generation unit 202 generates the control information for controlling turning on and off of each of the traffic light machines 130 disposed on the planned moving route represented by the planned moving route information.

Specifically, the control information generation unit 202 generates the control information in consideration of a time required for a pedestrian to become able to cross, in addition to a method similar to that of the control information generation unit 102 described above. For example, with a constraint condition that the pedestrian waiting in front of the pedestrian crossing can cross the pedestrian crossing within a predetermined time after the pedestrian is detected, the control information generation unit 202 may generate the control information in such a way that the evaluation value is improved within the range of the constraint condition. The traffic light machine 130 at an intersection where the vehicle plans to pass is disposed on the planned moving route, and when the pedestrian is waiting in front of the pedestrian crossing in order to cross the intersection where the vehicle plans to pass, the traffic light machine 130 which the pedestrian obeys is the traffic light machine 130 different from the traffic light machine 130 which the vehicle passes, but is related to the traffic light machine 130 which the vehicle passes. Thus, the control information generation unit 202 generates the control information by further using the detection result of the pedestrian near another traffic light machine 130 related to the traffic light machine 130 disposed on the planned moving route of the vehicle. Thereby, the traffic control system 3 according to the fourth example embodiment can enhance efficiency of traffic including the pedestrian.

### Fifth Example Embodiment

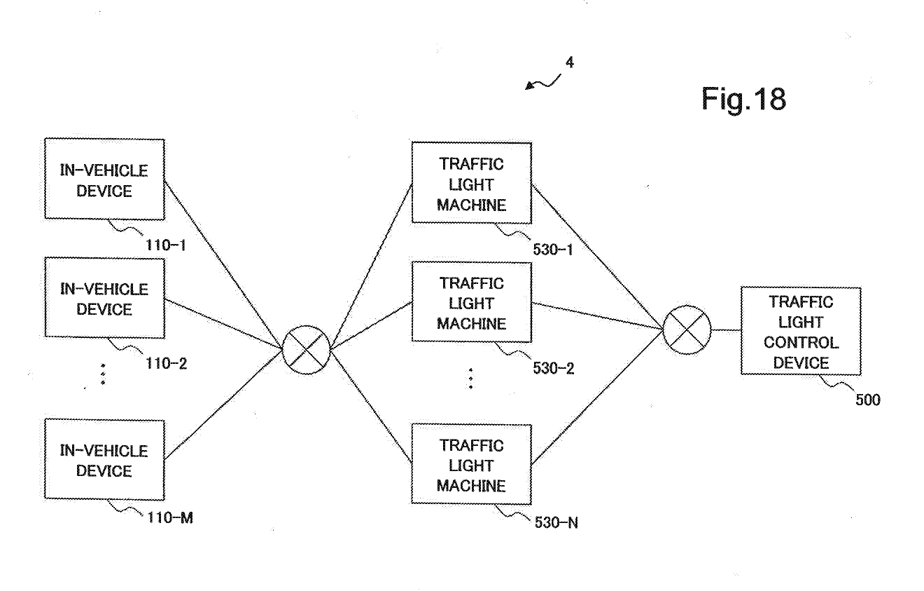

A fifth example embodiment is described in detail with reference to the drawings. First, one example of a configuration of a traffic control system 4 according to the fifth example embodiment is illustrated in FIG. 18. As illustrated in FIG. 18, the traffic control system 4 according to the fifth example embodiment includes one or more in-vehicle devices (110-1 to 110-M), a traffic light control device 500, and one or more traffic light machines (530-1 to 530-N). Note that the traffic light machines (530-1 to 530-N) are referred to as a traffic light machine 530 when not distinguished from one another or when generically called. A difference between the traffic control systems 1 to 3 described above and the traffic control system 4 is that the in-vehicle device 110 is communicably connected to the traffic light machine 530.

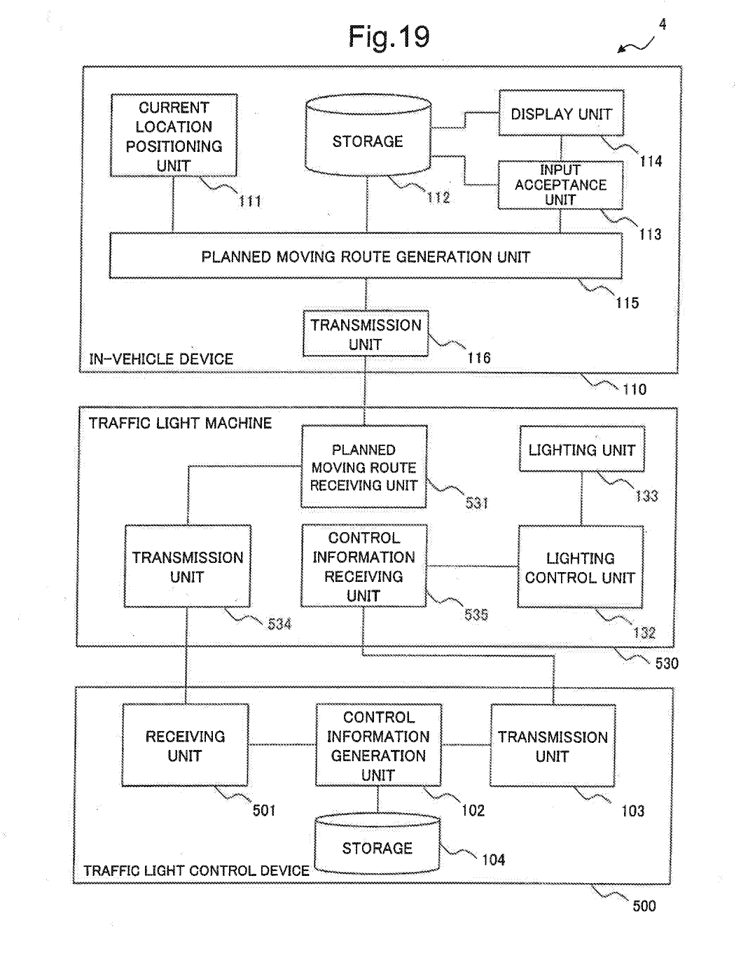

Next, a functional configuration of the traffic control system 4 according to the fifth example embodiment is described with reference to FIG. 19. FIG. 19 is a functional block diagram illustrating one example of the functional configuration of the traffic control system 4 according to the fifth example embodiment. Note that, for convenience of description, the same reference sign is given to a component similar to the component described in each of the above-described example embodiments, and a description thereof is omitted.

As illustrated in FIG. 19, the traffic light machine 530 includes a planned moving route receiving unit 531, the lighting control unit 132, the lighting unit 133, a transmission unit 534, and a control information receiving unit 535.

The planned moving route receiving unit 531 receives the planned moving route information output from the in-vehicle device 110, together with the current location information. The planned moving route receiving unit 531 supplies the received planned moving route information to the transmission unit 534 together with the current location information.

The transmission unit 534 receives the planned moving route information from the planned moving route receiving unit 531 together with the current location information. The transmission unit 534 transmits the received planned moving route information to the traffic light control device 500 together with the current location information.

In a way similar to the receiving unit 131 described above, the control information receiving unit 535 receives the control information transmitted from the traffic light control device 500, and supplies the control information to the lighting control unit 132.

Note that all of the traffic light machines 530 receiving the control information may receive the planned moving route information, or some of the traffic light machines 530 may receive the planned moving route information. In other words, some or all of a plurality of traffic light machines 530 may each include the planned moving route receiving unit 531 and the transmission unit 534.

Furthermore, the traffic light control device 500 includes a receiving unit 501, the control information generation unit 102, the transmission unit 103, and the storage 104. In a way similar to the receiving unit 101, the receiving unit 501 receives the planned moving route information together with the current location information. The difference between the receiving unit 501 and the receiving unit 101 is that the planned moving route information is received not from the in-vehicle device 110 but from the traffic light machine 530.

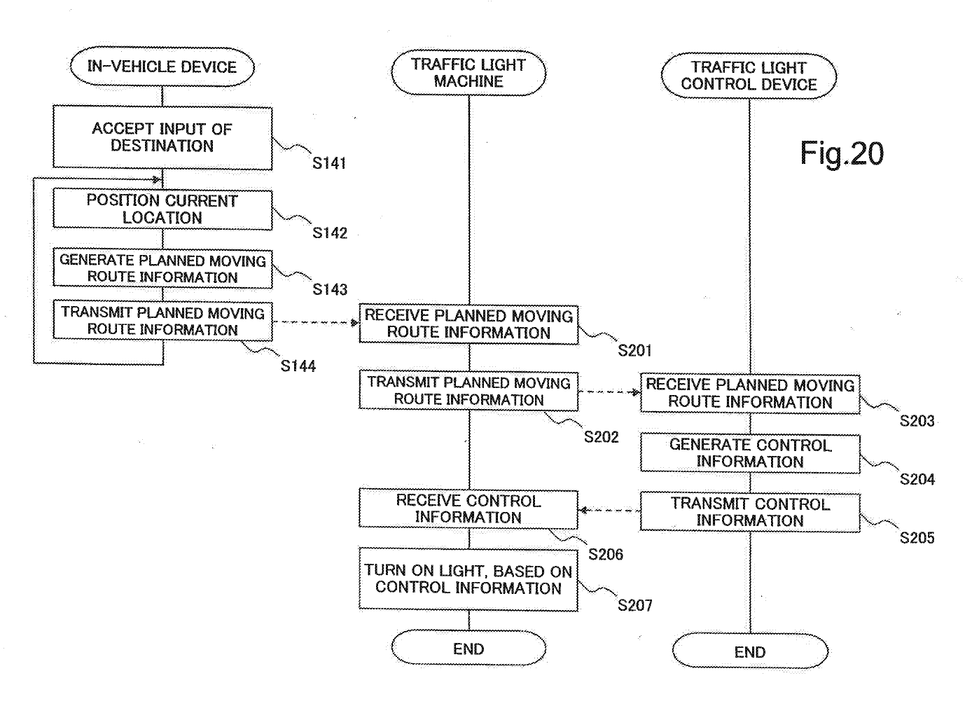

Next, an operation according to the fifth example embodiment is described with reference to FIG. 20. In FIG. 20, an operation of the in-vehicle device 110 is illustrated on a left side, an operation of the traffic light machine 530 is illustrated in a center, an operation of the traffic light control device 500 is illustrated on a right side, and a broken-line arrow between each operation represents flow of information.

First, the input acceptance unit 113 accepts a destination input by a driver (step S141). The current location positioning unit 111 positions a current location (step S142). Then, the planned moving route generation unit 115 generates the planned moving route information on the planned moving route from the current location to the destination, by use of the destination input in S141, the current location positioned in S142, and the road map information stored in the storage 112 (step S143). Then, the transmission unit 116 transmits the current location information and the planned moving route information to the traffic light machine 530 (step S144). Then, the in-vehicle device 110 repeats step S142 to step S144.

The traffic light machine 530 to which the in-vehicle device 110 transmits the planned moving route information may be any one of a plurality of traffic light machines 530 disposed within a predetermined distance from the in-vehicle device 110, may be the traffic light machine 530 at a nearest distance from the in-vehicle device 110, or may be any other traffic light machine 530.

The planned moving route receiving unit 531 of the traffic light machine 530 receives the planned moving route information together with the current location information (step S201). Then, the transmission units 534 transmits the planned moving route information to the traffic light control device 500 together with the current location information (step S202).

The receiving unit 501 of the traffic light control device 500 receives the planned moving route information together with the current location information (step S203). Then, the control information generation unit 102 generates the control information as in step S146 described above (step S204). Thereafter, the transmission unit 103 transmits the control information to a corresponding traffic light machine 130 as in step S147 described above (step S205).

Then, the control information receiving unit 535 of the traffic light machine 530 being a transmission destination of the control information receives the control information as in step S148 described above (step S206). Note that the traffic light machine 530 receiving the control information may be a traffic light machine being different from or the same as the traffic light machine 530 which has executed step S201 and step S202.

Then, the lighting control unit 132 of the traffic light machine 530 controls the lighting unit 133 based on the control information, as in step S149 described above (step S207). Thus, the lighting unit 133 can turn on a color based on the control of the lighting control unit 132 at the timing based on the control information and for the time period based on the control information.

As described above, the traffic control system 4 according to the fifth example embodiment has a configuration in which the planned moving route information output by the in-vehicle device 110 is input to the traffic light control device 500 via the traffic light machine 530. By employing such a configuration, each in-vehicle device 110 does not need to have a long-distance communication capability, and needs only to be able to perform short-distance communication with the traffic light machine 530. Because the traffic light machine 530 may be connected to the traffic light control device 500 in a wired form, it is possible to apply the traffic control system 4 according to the fifth example embodiment to even an environment having an unsatisfactory wireless communication infrastructure. Note that a configuration in which the traffic light machine 530 receives the planned moving route information as in the traffic control system 4 according to the fifth example embodiment is also applicable to the traffic control system 2 and the traffic control system 3 described above.

(Regarding Hardware Configuration)

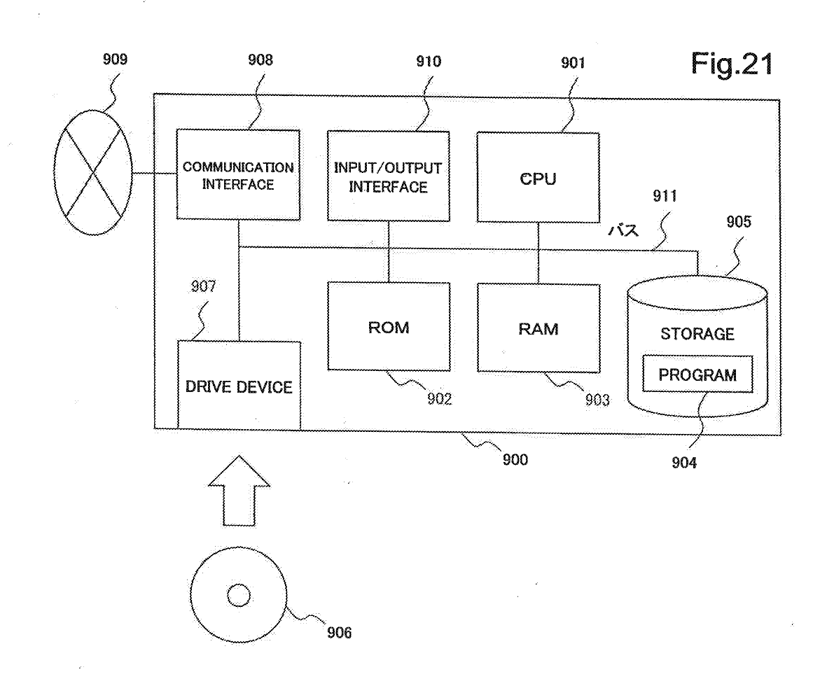

In each example embodiment of the present disclosure, each component of each device represents a block in a functional unit. Each component of each device is partly or entirely achieved by any combination of an information processing device 900 and a program, for example, as illustrated in FIG. 21. FIG. 21 is a block diagram illustrating one example of a hardware configuration of the information processing device 900 which achieves each component of each device. The information processing device 900 includes the following components as one example.
Central processing unit (CPU) 901
Read only memory (ROM) 902
Random access memory (RAM) 903
Program 904 loaded onto RAM 903
Storage 905 storing program 904
Drive device 907 which reads and writes in recording medium 906
Communication interface 908 connected to communication network 909
Input/output interface 910 which inputs/outputs data
Bus 911 connecting each component

Each component of each device in each example embodiment is achieved when the CPU 901 acquires and executes the program 904 which achieves a function of the component. The program 904 which achieves the function of each component of each device is, for example, previously stored in the storage 905 or the ROM 902, and is read by the CPU 901 as needed. Note that the program 904 may be supplied to the CPU 901 via the communication network 909, or may be previously stored in the recording medium 906, and the drive device 907 may read the program and supply the program to the CPU 901.

There are various modification examples of a method of achieving each device. For example, each device may be achieved by any combination of each separate information processing device 900 for each component and a program. Also, a plurality of components included in each device may be achieved by any combination of one information processing device 900 and a program.

Furthermore, each component of each device is partly or entirely achieved by any other general-purpose or dedicated circuit, processor, or the like, or by a combination thereof. These may be configured by a single chip, or a plurality of chips connected via a bus.

Each component of each device may be partly or entirely achieved by a combination of the above-described circuit or the like and a program.

When each component of each device is partly or entirely achieved by a plurality of information processing devices, circuits, and the like, the plurality of information processing devices, circuits, or the like may be arranged in a centralized or distributed form. For example, information processing devices, circuits, or the like may be achieved in a form such as a client-and-server system or a cloud computing system in which the information processing devices, the circuits, or the like are each connected to one another via a communication network.

Note that each example embodiment described above is a preferred example embodiment of the present disclosure, and a scope of the present disclosure is not limited to each example embodiment described above, and a person skilled in the art may modify or substitute each example embodiment described above without departing from the spirit of the present disclosure, and construct a form in which various alterations are made.

Some or all of the example embodiments described above may also be described as in Supplementary notes below, but are not limited to the followings.

(Supplementary Note 1)

A traffic light control device including:

a control information generation unit that, based on planned moving route information representing a planned moving route of a vehicle calculated using a current location of the vehicle and a destination of the vehicle, generates control information on controlling turning on and off a traffic light machine on the planned moving route; and

a transmission unit that transmits the control information to the traffic light machine to be controlled.

(Supplementary Note 2)

The traffic light control device according to Supplementary note 1, wherein the control information generation unit generates the control information about the traffic light machine on the planned moving route of the vehicle in order that a total of planned moving time for one or each of a plurality of the vehicles to move from the current location to the destination becomes minimum.

(Supplementary Note 3)

The traffic light control device according to Supplementary note 1, wherein the control information generation unit generates the control information about the traffic light machine on the planned moving route of the vehicle in order that an average value of average speeds of one or each of a plurality of the vehicles from the current location to the destination becomes maximum.

(Supplementary Note 4)

The traffic light control device according to Supplementary note 2, wherein the control information generation unit weights the planned moving time depending on an attribute of one or each of a plurality of the vehicles, and generates the control information about the traffic light machine on the planned moving route of the vehicle in order that a total of the weighted planned moving time becomes minimum.

(Supplementary Note 5)

The traffic light control device according to any one of Supplementary notes 1 to 4, wherein the control information generation unit generates the control information about the traffic light machine on the planned moving route of the vehicle in order that the vehicle satisfies a predetermined constraint condition.

(Supplementary Note 6)

The traffic light control device according to any one of Supplementary notes 1 to 5, wherein the planned moving route information is information on at least a part of a route from the current location to the destination.

(Supplementary Note 7)

The traffic light control device according to any one of Supplementary notes 1 to 6, wherein the control information generation unit generates control information about the traffic light machine by further using a detection result of a pedestrian near another traffic light machine related to the traffic light machine.

(Supplementary Note 8)

A traffic control system including:

an in-vehicle device that calculates a planned moving route of a vehicle using a current location of the vehicle and a destination of the vehicle and transmits planned moving route information on the planned moving route;

a traffic light control device; and

a traffic light machine,

wherein the traffic light control device includes
a control information generation unit that, based on the planned moving route information, generates control information on controlling turning on and off a traffic light machine on the planned moving route; and
a transmission unit that transmits the control information to the traffic light machine to be controlled,

wherein the traffic light machine includes
a light instrument; and
a lighting control unit that controlling turning on and off the light instrument based on the control information.

(Supplementary Note 9)

The traffic control system according to Supplementary note 8, wherein the in-vehicle device transmits the planned moving route information to one of the traffic light machines within a predetermined range of distance from a vehicle mounted with the in-vehicle device,

the traffic light machine further includes
a planned moving route reception unit that receives the planned moving route information; and
a transmission unit that transmits the received planned moving route information to the traffic light control device,

the control information generation unit of the traffic light control device generates the control information using the planned moving route information transmitted from the traffic light machine.

(Supplementary Note 10)

The traffic control system according to Supplementary note 8 or 9, wherein the control information generation unit generates the control information for the traffic light machine on the planned moving route of the vehicle in order that a total of planned moving times taken for one or each of a plurality of the vehicles to moving from the current location to the destination becomes minimum.

(Supplementary Note 11)

The traffic control system according to Supplementary note 8 or 9, wherein the control information generation unit generates the control information for the traffic light machine in the planned moving route information of the vehicle in order that an average value of average speeds of one or each of a plurality of the vehicles from the current location to the destination becomes maximum.

(Supplementary Note 12)

The traffic control system according to Supplementary note 10, wherein the control information generation unit weights the planned moving times according to an attribute of one or each of a plurality of the vehicles, and generates the control information for the traffic light machine on the planned moving route of the vehicle in order that a total of the weighted planned moving times becomes minimum.

(Supplementary Note 13)

The traffic control system according to any one of Supplementary notes 8 to 12, wherein the control information generation unit generates the control information for the traffic light machine on the planned moving route of the vehicle in order that the vehicle satisfies a predetermined constraint condition.

(Supplementary Note 14)

The traffic control system according to any one of Supplementary notes 8 to 13, wherein the in-vehicle device includes

a display unit that displays an selectable condition to designate a part to be output out of the calculated planned moving route;

an acceptance unit that accepts information on a selected condition; and

a partial route generation unit that generates a partial route being at least a part of the planned moving route based on the planned moving route information and the accepted condition,

wherein the in-vehicle device outputs, as the planned moving route information, information on the partial route.

(Supplementary Note 15)

The traffic control system according to any one of Supplementary notes 8 to 14, wherein the control information generation unit generates the control information on the traffic light machine by further using a detection result of a pedestrian near another traffic light machine related to the traffic light machine.

(Supplementary Note 16)

The traffic control system according to Supplementary note 15, further including a roadside device including
a detection unit that detects the pedestrian near the another traffic light machine; and
a transmission unit that transmits the detection result of the pedestrian to the traffic light control device,

wherein the control information generation unit generates the control information by further using the detection result transmitted from the roadside device.

(Supplementary Note 17)

A traffic light control method including:

based on planned moving route information representing a planned moving route of a vehicle calculated using a current location of the vehicle and a destination of the vehicle, generating control information on controlling turning on and off a traffic light machine on the planned moving route; and

transmitting the control information to the traffic light machine to be controlled.

(Supplementary Note 18)

The traffic light control method according to Supplementary note 17, wherein the control information about the traffic light machine on the planned moving route of the vehicle is generated in order that a total of planned moving time for one or each of a plurality of the vehicles to move from the current location to the destination becomes minimum.

(Supplementary Note 19)

A computer-readable non-transitory recording medium recording a program which causes a computer to execute:

based on planned moving route information representing a planned moving route of a vehicle calculated using a current location of the vehicle and a destination of the vehicle, generating control information on controlling turning on and off of a traffic light machine on the planned moving route; and

transmitting the control information to the traffic light machine to be controlled.

(Supplementary Note 20)

The recording medium according to Supplementary note 19, wherein, when generating the control information, generating the control information about the traffic light machine on the planned moving route of the vehicle in order that a total of planned moving time for one or each of a plurality of the vehicles to move from the current location to the destination becomes minimum.

(Supplementary Note 21)

A traffic control method in a system including an in-vehicle device, a traffic light machine control device, and a traffic light machine, wherein

the in-vehicle device calculates a planned moving route of a vehicle based on a current location of the vehicle and a destination of the vehicle, and outputs planned moving route information representing the planned moving route,

the traffic light control device generates control information on controlling turning on and off of a traffic light machine on the planned moving route based on the planned moving route information, and transmits the control information to the traffic light machine to be controlled, and

the traffic light machine controls turning on and off of light instrument based on the control information.

(Supplementary Note 22)

The traffic control method according to Supplementary note 21, wherein

the in-vehicle device transmits the planned moving route information to one of the traffic light machines within a predetermined range of distance from the vehicle mounted with the in-vehicle device,

the traffic light machine
receives the planned moving route information, and
transmits the received planned moving route information to the traffic light control device, and

the traffic light control device generates the control information based on the planned moving route information transmitted from the traffic light machine.

This application is based upon and claims the benefit of priority from Japanese Patent Application No. 2016-118982, filed on Jun. 15, 2016, the disclosure of which is incorporated herein in its entirety by reference.

### REFERENCE SIGNS LIST

1 Traffic control system
2 Traffic control system
3 Traffic control system
4 Traffic control system
10 Traffic light control device
11 Control information generation unit
12 Transmission unit
100 Traffic light control device
101 Receiving unit
102 Control information generation unit
103 Transmission unit
104 Storage
110 In-vehicle device
111 Current location positioning unit
112 Storage
113 Input acceptance unit
114 Display unit
115 Planned moving route generation unit
116 Transmission unit
130 Traffic light machine
131 Receiving unit
132 Lighting control unit
133 Lighting unit
200 Traffic light control device
201 Receiving unit
202 Control information generation unit
210 In-vehicle device
212 Storage
213 Input acceptance unit
214 Display unit
217 Partial route generation unit
340 Roadside device
341 Detection unit
342 Transmission unit
500 Traffic light control device
501 Receiving unit
530 Traffic light machine
531 Planned moving route receiving unit
534 Transmission unit
535 Control information receiving unit

1. A traffic light control device comprising
a processor configured to:
based on planned moving route information representing a planned moving route of a vehicle calculated using a current location of the vehicle and a destination of the vehicle, generate control information on controlling turning on and off a traffic light machine on the planned moving route; and
transmit the control information to the traffic light machine to be controlled.

2. The traffic light control device according to claim 1, wherein the processor generates the control information about the traffic light machine on the planned moving route of the vehicle in order that a total of planned moving time for one or each of a plurality of the vehicles to move from the current location to the destination becomes minimum.

3. The traffic light control device according to claim 1, wherein the processor generates the control information about the traffic light machine on the planned moving route of the vehicle in order that an average value of average speeds of one or each of a plurality of the vehicles from the current location to the destination becomes maximum.

4. The traffic light control device according to claim 2, wherein the processor weights the planned moving time depending on an attribute of one or each of a plurality of the vehicles, and generates the control information about the traffic light machine on the planned moving route of the vehicle in order that a total of the weighted planned moving time becomes minimum.

5. The traffic light control device according to claim 1, wherein the processor generates the control information about the traffic light machine on the planned moving route of the vehicle in order that the vehicle satisfies a predetermined constraint condition.

6. The traffic light control device according to claim 1, wherein the planned moving route information is information on at least a part of a route from the current location to the destination.

7. The traffic light control device according to claim 1, wherein the processor generates control information about the traffic light machine by further using a detection result of a pedestrian near another traffic light machine related to the traffic light machine.

8-12. (canceled)

13. A traffic light control method comprising:
by a processor,
based on planned moving route information representing a planned moving route of a vehicle calculated using a current location of the vehicle and a destination of the vehicle, generating control information on controlling turning on and off a traffic light machine on the planned moving route; and
transmitting the control information to the traffic light machine to be controlled.

14. The traffic light control method according to claim 13, wherein the control information about the traffic light machine on the planned moving route of the vehicle is generated in order that a total of planned moving time for one or each of a plurality of the vehicles to move from the current location to the destination becomes minimum.

15. A non-transitory computer-readable recording medium recording a program which causes a computer to execute:
based on planned moving route information representing a planned moving route of a vehicle calculated using a current location of the vehicle and a destination of the vehicle, generating control information on controlling turning on and off of a traffic light machine on the planned moving route; and
transmitting the control information to the traffic light machine to be controlled.

16. The recording medium according to claim 15, wherein, when generating the control information, generating the control information about the traffic light machine on the planned moving route of the vehicle in order that a total of planned moving time for one or each of a plurality of the vehicles to move from the current location to the destination becomes minimum.

17-18. (canceled)
